(19) United States
(12) Patent Application Publication
(10) Pub. No.: US 2014/0320929 A1
(43) Pub. Date: Oct. 30, 2014

(54) IMAGE READING APPARATUS AND IMAGE FORMING APPARATUS INCLUDING THE SAME

(71) Applicant: CANON KABUSHIKI KAISHA, Tokyo (JP)

(72) Inventors: Hiroshi Kato, Odawara-shi (JP); Hiroki Kato, Gotemba-shi (JP); Kazushi Ino, Suntou-gun (JP); Daisuke Kaneko, Suntou-gun (JP); Ichiro Yasumaru, Mishima-shi (JP); Atsushi Ogata, Mishima-shi (JP)

(21) Appl. No.: 14/264,750

(22) Filed: Apr. 29, 2014

(30) Foreign Application Priority Data
Apr. 30, 2013 (JP) 2013-096024
Apr. 30, 2013 (JP) 2013-096025
Apr. 22, 2014 (JP) 2014-088606

(51) Int. Cl. H04N 1/00

(52) U.S. Cl. CPC H04N 1/00557
USPC 358/296

(57) ABSTRACT

An image reading apparatus includes a reading unit having a reading surface and being rotatable about an axis of rotation, and a facing member that comes into contact with the reading unit and faces the reading surface when the reading unit is at a reading position. The reading unit is capable of reading a portion of an object that faces the reading surface when the reading unit is at the reading position. When the reading unit is at a position other than the reading position, the reading surface is positioned nearer to the axis of rotation than when the reading unit is at the reading position and the reading unit is spaced apart from the facing member.

### BACKGROUND OF THE INVENTION

1. Field of the Invention

The present invention relates to an image reading apparatus, as represented by an automatic document feeder unit (ADF), configured to read an image or the like on an original, and to an image forming apparatus, such as a copier, a laser beam printer (LBP), or a facsimile, including the image reading apparatus.

2. Description of the Related Art

In a known configuration, reading portions (image sensors) are provided at positions of an original conveying path that face the front side and the back side, respectively, of an original so that the two sides (the front side and the back side) of the original are automatically read by the image reading apparatus described above. In such a configuration, however, two reading sensors for the front side and the back side, respectively, of the original are necessary, and the cost increases.

Accordingly, a configuration is disclosed by Japanese Patent Laid-Open No. 10-126567 in which one reading unit is movably provided in a main body of an apparatus, so that originals that are in different conveying paths are readable with the one reading unit.

To read an image on an original accurately in a case where a sensor, such as a contact image sensor (CIS), having a small depth of field and a short focal length is used as a reading unit for the purpose of reducing the apparatus size or any other purpose, it is necessary to suppress the flapping of the original that may occur when the original is read. Therefore, the gap between a portion of the reading unit that faces the original and a portion of a guide member defining the conveying path that faces the reading unit is set to a small value to some extent.

In a case where the reading unit is movable as disclosed by Japanese Patent Laid-Open No. 10-126567, however, if the gap between the portion of the reading unit that faces the original and the portion of the guide member that faces the reading unit is small, the reading unit or the portion of the reading unit that faces the original may interfere with the portion of the guide member that faces the reading unit or any other portion of the guide member when the reading unit is moved. Such an interference may hinder the movement of the reading unit or may damage the reading unit and the guide member.

In a case where a reading unit is included in an image forming apparatus that includes a fixing device, when a sheet that has been heated by passing through the fixing device passes a position facing the reading unit, the heat of the sheet may raise the temperatures of elements, such as a light source, an imaging element, and a sensor (an image pickup element), included in the reading unit. Consequently, the reading accuracy of the reading unit may be deteriorated, or the reading unit may be damaged.

### SUMMARY OF THE INVENTION

An object of the present invention is to suppress the interference between a reading unit and a guide member that may occur when the reading unit is moved.

Another object of the present invention is to suppress the deterioration in the reading accuracy of the reading unit and the damage to the reading unit that may occur with the rise of the temperature of the reading unit due to the heat of a sheet.

According to an aspect of the present invention, there is provided an image reading apparatus including a reading unit having a reading surface and being rotatable about an axis of rotation, the reading unit being capable of reading a portion of an object that faces the reading surface when the reading unit is at a reading position; and a facing member that comes into contact with the reading unit and faces the reading surface when the reading unit is at the reading position. When the reading unit is at a position other than the reading position, the reading surface is positioned nearer to the axis of rotation than when the reading unit is at the reading position and the reading unit is spaced apart from the facing member.

According to another aspect of the present invention, there is provided an image forming apparatus including a reading unit that reads an image on a sheet that is to face a reading surface thereof; a facing surface that forms at least a portion of a conveying path along which the sheet is conveyed, the facing surface facing the reading unit; a transfer portion where a toner image is transferred to a recording material; and a fixing portion that fixes the toner image to the recording material by heating the recording material to which the toner image has been transferred. The recording material that has passed through the fixing portion is conveyed along the conveying path. The reading unit is movable between a reading position where the reading unit reads the sheet residing between the reading surface and the facing surface and a retracted position where the reading surface is farther from the facing surface than when the reading unit is at the reading position. The reading unit is at the retracted position when the recording material that has passed through the fixing portion is conveyed along the conveying path.

Further features of the present invention will become apparent from the following description of exemplary embodiments with reference to the attached drawings.

### BRIEF DESCRIPTION OF THE DRAWINGS

FIG. 1 is a schematic sectional view of a reading apparatus;

FIG. 2 is a schematic sectional view of the reading apparatus;

FIG. 3 is an exploded perspective view of a reading unit;

FIG. 4 is a perspective view of a mechanism of holding the reading unit;

FIGS. 5A and 5B are perspective views of cam members;

FIG. 6 is a schematic sectional view of part of the reading apparatus illustrating the reading unit and peripheral elements;

FIG. 7A is a perspective view of a conveyance guide;

FIG. 7B is a sectional view of the conveyance guide;

FIG. 8 is another schematic sectional view of part of the reading apparatus illustrating the reading unit and the peripheral elements;

FIG. 9 is a graph illustrating the change in the distance between an observation point on a glass plate and the axis of rotation of the reading unit that occurs with the change in the phase of rotation of the reading unit;

FIG. 10 is a perspective view of part of a reading unit;

FIG. 11 is a schematic sectional view of part of a reading apparatus illustrating the reading unit and peripheral elements;

FIG. 12 is another schematic sectional view of part of the reading apparatus illustrating the reading unit and the peripheral elements;

FIG. 13 is a graph illustrating the change in the distance between a movable guide and the axis of rotation of the reading unit that occurs with the change in the phase of rotation of the reading unit;

FIG. 14 is a schematic sectional view of part of a reading apparatus illustrating a reading unit and peripheral elements;

FIG. 15 is another schematic sectional view of part of the reading apparatus illustrating the reading unit and the peripheral elements;

FIG. 16 is a schematic sectional view of an image forming apparatus;

FIG. 17A is a schematic sectional view of the image forming apparatus illustrating an image forming process;

FIG. 17B is another schematic sectional view of the image forming apparatus illustrating the image forming process;

FIG. 18A is yet another schematic sectional view of the image forming apparatus illustrating the image forming process;

FIG. 18B is yet another schematic sectional view of the image forming apparatus illustrating the image forming process;

FIG. 19A is a schematic sectional view of the image forming apparatus illustrating an original reading process;

FIG. 19B is another schematic sectional view of the image forming apparatus illustrating the original reading process;

FIG. 20A is yet another schematic sectional view of the image forming apparatus illustrating the original reading process;

FIG. 20B is yet another schematic sectional view of the image forming apparatus illustrating the original reading process;

FIG. 21A is a schematic sectional view of the image forming apparatus illustrating a duplex copying operation;

FIG. 21B is another schematic sectional view of the image forming apparatus illustrating the duplex copying operation;

FIG. 22A is yet another schematic sectional view of the image forming apparatus illustrating the duplex copying operation;

FIG. 22B is yet another schematic sectional view of the image forming apparatus illustrating the duplex copying operation;

FIG. 23A is yet another schematic sectional view of the image forming apparatus illustrating the duplex copying operation;

FIG. 23B is yet another schematic sectional view of the image forming apparatus illustrating the duplex copying operation;

FIG. 24A is yet another schematic sectional view of the image forming apparatus illustrating the duplex copying operation;

FIG. 24B is yet another schematic sectional view of the image forming apparatus illustrating the duplex copying operation;

FIG. 25A is yet another schematic sectional view of the image forming apparatus illustrating the duplex copying operation;

FIG. 25B is yet another schematic sectional view of the image forming apparatus illustrating the duplex copying operation;

FIG. 26 is yet another schematic sectional view of the image forming apparatus illustrating the duplex copying operation;

FIG. 27A is a schematic sectional view of part of the image forming apparatus illustrating a reading unit and peripheral elements; and

FIG. 27B is another sectional view of part of the image forming apparatus illustrating the reading unit and the peripheral elements.

### DESCRIPTION OF THE EMBODIMENTS

### First Embodiment

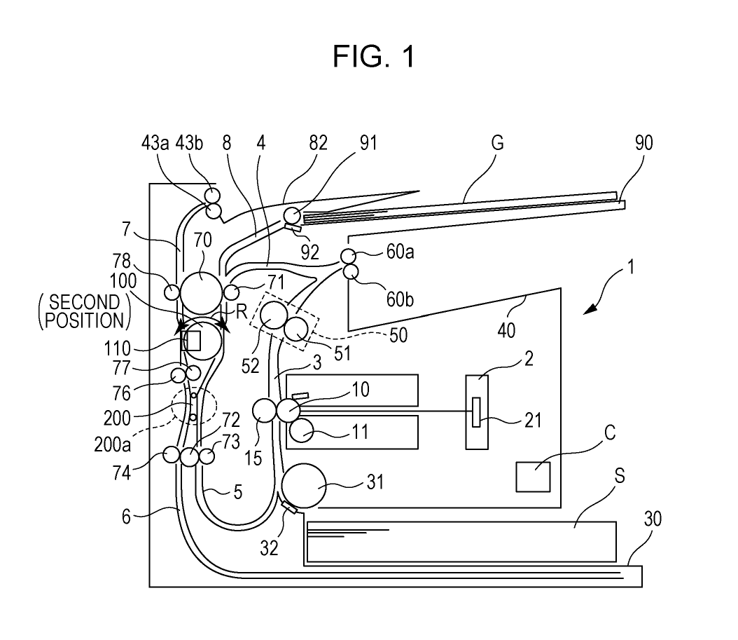

A first embodiment concerns an image reading apparatus to which the present invention is applied. Sectional views to be referred to below are all seen in a width direction of an original G (a direction orthogonal to a direction of conveyance of the original G). FIG. 1 is a schematic sectional view of an image reading apparatus 1. The image reading apparatus 1 according to the first embodiment includes an image forming section (corresponding to an image forming unit) serving as an image forming apparatus, which will be described in detail separately below. Therefore, the image reading apparatus 1 is also regarded as an image forming apparatus including an image reading apparatus.

First, an outline of the apparatus 1 will be described. The apparatus 1 has a conveying path 3 defined therein and along which a recording material S (a sheet) is conveyed from a first feed unit 30 provided at the bottom of the apparatus 1 to a first discharge portion 40 provided at the top of the apparatus 1. The apparatus 1 also has conveying paths 4 and 5 defined therein and along which the recording material S that has been switched back in a case of duplex printing is conveyed to the conveying path 3 again, a first original-conveying path 8 along which the original G (another sheet) is conveyed from a second feed unit 90 provided at the top of the apparatus 1 to the conveying path 4, and second original-conveying paths 6 and 7 defined therein and along which the original G that is conveyed along the conveying path 5 is switched back and is conveyed to a second discharge portion 82 provided at the top of the apparatus 1.

### Image Forming Section

The apparatus 1 includes, in a central part thereof, a rotatable photoconductor drum 10 as a photoconductive member, and a developing roller 11 that is in contact with the photoconductor drum 10 and is configured to rotate while carrying toner. An optical unit 2 that emits laser light is provided in such a manner as to face the photoconductor drum 10. A transfer roller 15 is provided at a position across the conveying path 3 from the photoconductor drum 10. A fixing portion 50 is provided at a position of the conveying path 3 that is on the downstream side with respect to the transfer roller 15 in the direction of conveyance. A combination of the first feed unit 30, the conveying path 3, the photoconductor drum 10, the developing roller 11, the optical unit 2, the fixing portion 50, the first discharge portion 40, and the conveying paths 4 and 5 serves as at least an image forming section that forms an image on the recording material S.

Referring to FIG. 1, an image forming operation performed by the image forming section will now be described. When the image forming section receives a print signal, the image forming section starts the image forming operation as follows. A light-emitting portion 21 included in the optical unit 2 emits laser light to the surface of the photoconductor drum 10 that has been charged by a charging unit (not illustrated) and is in rotation. The laser light is generated on the basis of information on an image to be printed. Thus, a latent image corresponding to the information on the image to be printed is formed on the surface of the photoconductor drum 10 that has received the laser light. Subsequently, the developing roller 11 that is in rotation gives the toner carried thereon to the surface of the photoconductor drum 10, whereby a toner image corresponding to the latent image is formed on the surface of the photoconductor drum 10.

Meanwhile, recording materials S stored in the first feed unit 30 are each conveyed to the conveying path 3 by a pickup roller 31 and a separating member 32. In the conveying path 3, the recording material S is conveyed to a transfer nip, which is formed between the photoconductor drum 10 and the transfer roller 15, in accordance with the timing of conveyance of the toner image formed on the surface of the photoconductor drum 10.

The toner image formed on the surface of the photoconductor drum 10 is conveyed to the transfer nip, i.e., a position facing the transfer roller 15, with the rotation of the photoconductor drum 10, and is transferred to the recording material S with a transfer bias that is applied to the transfer roller 15. The recording material S having the toner image transferred thereto is conveyed to the fixing portion 50, is heated and pressed by passing through a fixing nip formed between a heat roller 51 and a pressure roller 52, whereby the toner image is fixed to the recording material S. The recording material S having the toner image fixed thereto is conveyed toward the downstream side of the fixing portion 50 by discharge rollers 60a and 60b.

Here, in a case of simplex printing in which printing is performed only on one side of the recording material S, the discharge rollers 60a and 60b convey the recording material S directly to the outside of the apparatus 1, that is, the discharge rollers 60a and 60b discharge the recording material S onto the first discharge portion 40.

In the case of duplex printing in which printing is performed on both sides of the recording material S, the recording material S that is conveyed toward the downstream side of the fixing portion 50 is conveyed by the discharge rollers 60a and 60b until the trailing end of the recording material S passes a point of the conveying path 3 from which the conveying path 4 extends. Subsequently, the discharge rollers 60a and 60b rotate backward, whereby the recording material S whose trailing end now serves as the leading end is guided and conveyed to the conveying path 4 by a flapper (not illustrated) provided at the point of the conveying path 3 from which the conveying path 4 extends. This is so-called switchback.

The recording material S that has been switched back is conveyed along the conveying paths 4 and 5 by conveying rollers 70, 71, 72, and 73 (a flapper 200 is at a position 200a) and is further conveyed along the conveying path 3 again into the transfer nip between the photoconductor drum 10 and the transfer roller 15. Subsequently, another image forming operation is performed as described above, that is, another toner image is transferred and fixed to the other side of the recording material S. Then, the recording material S is discharged to the first discharge portion 40. When the recording material S is conveyed along the conveying path 4, a glass plate 110 is at a position facing the second original-conveying path 7 as illustrated in FIG. 1 so that foreign substances, dust, and the like adhered to the recording material S do not adhere to a reading device 100 or the heat of the recording material S is not easily transmitted to the reading device 100.

In such an image forming operation, an image is formed on one side or each of both sides of the recording material S.

### Image Reading Section

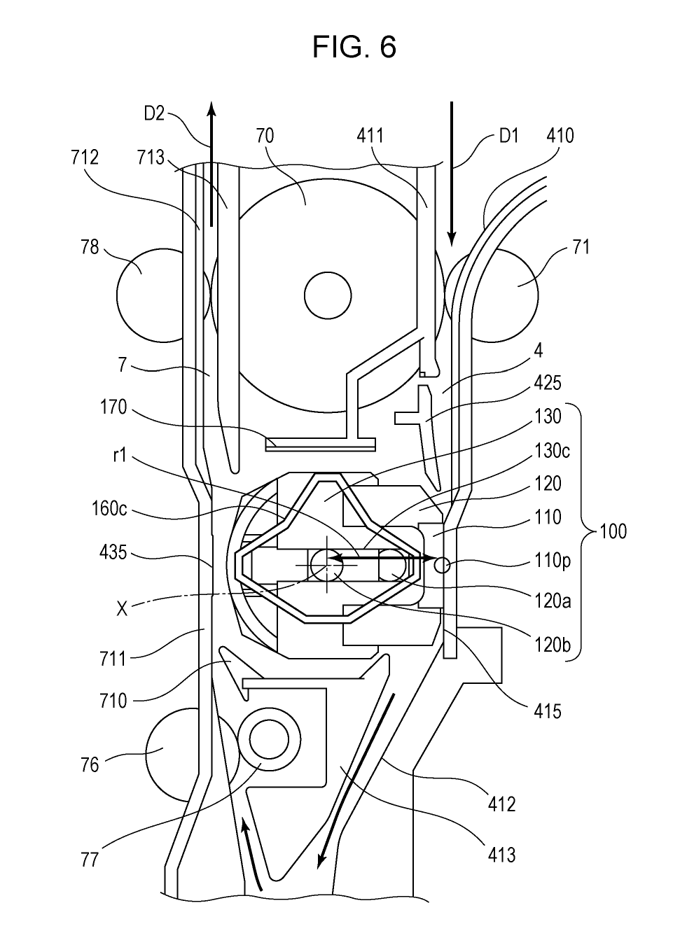

The image reading apparatus 1 according to the first embodiment includes an image reading section serving as an image reading apparatus that reads an image on the original G, which is in the form of a sheet. Specifically, the apparatus 1 includes the second feed unit 90, the first original-conveying path 8, the conveying paths 4 and 5, the second original-conveying paths 6 and 7, the flapper 200, conveying rollers 70, 71, 72, 73, 74, 76, 77, 78, 43a, and 43b, the reading device 100, and a white reference portion 170 (see FIG. 6) as a reference portion. The foregoing elements serve as at least part of the image reading section. Furthermore, some of the elements included in the image reading section are shared with the image forming section described above. For example, the conveying paths 4 and 5 and the conveying rollers 70, 71, 72, and 73 are shared elements that also serve as part of the image forming section.

The reading device 100 (the image reading section) includes a contact image sensor (CIS). The CIS includes the glass plate 110 that is to face the original G. The reading device 100 is movable (rotatable). The reading device 100 outputs image data acquired as information representing an image on the original G that has been read to an image control unit C.

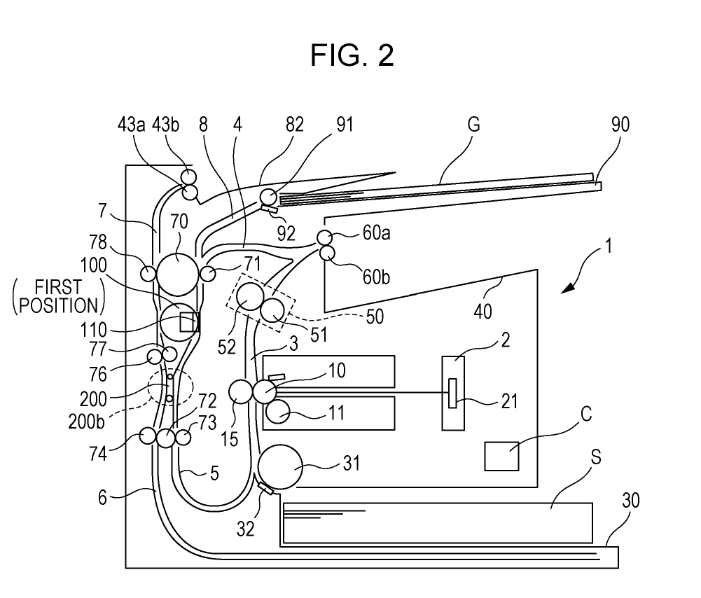

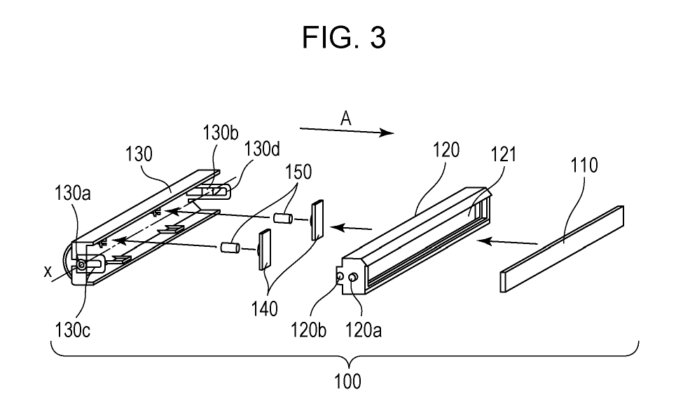

The reading device 100 is rotatable about its axis of rotation (denoted by X in FIG. 3) as illustrated by arrow R in FIG. 1 and is thus movable between a position (a first position illustrated in FIG. 2) where the reading device 100 reads an image on a first side of the original G that is in the conveying path 4 (a first conveying path) and a position (a second position illustrated in FIG. 1) where the reading device 100 reads an image on a second side of the original G that is in the second original-conveying path 7 (a second conveying path). When the reading device 100 is at the first position or the second position, the glass plate 110 faces a side of the original G that has an image to be read.

When the reading device 100 does not read the original G, the reading device 100 is at a standby position (a third position) defined between the first and second positions. In the first embodiment, the white reference portion 170 is provided vertically above the reading device 100 and faces vertically downward. A position where the glass plate 110 of the reading device 100 faces the white reference portion 170 corresponds to the standby position. When the reading device 100 is at the standby position, the reading device 100 can read the white reference portion 170. Reference information obtained as the result of reading the white reference portion 170 is defined as white reference information. Information representing the image on the original G (image data) that has been read is correctable on the basis of the white reference information. The correction of the information representing the image on the original G may be performed by the image control unit C on the basis of the white reference information. Alternatively, the information representing the image on the original G may be corrected by the reading device 100 on the basis of the white reference information, and the corrected information may be output as image information on the original G to the image control unit C. On the basis of the reference information acquired as the result of reading the white reference portion 170, the quantity of light to be emitted from a light source (not illustrated) included in the reading device 100 to the original G may be adjusted.

The image control unit C is capable of transmitting the image information from the reading device 100 to an external image processing device or storage device, such as a personal computer (PC), a server, or a universal-serial-bus (USB) memory over a network or the like, or transmitting the image information from the reading device 100 to the image forming section and thus forming an image on the basis of the image information. The image information may also be stored in a memory (storage device) or the like included in the image control unit C. The memory included in the image control unit C encompasses a memory provided on a circuit board on which the image control unit C is provided, and any other memories provided on separate circuit boards or the like that are provided in the apparatus 1.

### Image Reading Operation

An operation of reading the image information on the original G by the image reading section will now be described with reference to FIG. 2. FIG. 2 is a schematic sectional view of the image reading apparatus 1. Originals G placed on the second feed unit 90 are each fed by a pickup roller 91 and a separating member 92 and is conveyed along the first original-conveying path 8 to the conveying paths 4 and 5 by the conveying rollers 70 and 71.

Meanwhile, the reading device 100 reads the information on the white reference portion 170 at the standby position and corrects the white reference information before starting the reading of the first side, corresponding to the front side, of the original G that is fed thereto from the second feed unit 90. Then, the reading device 100 rotates clockwise in FIG. 2 and thus moves to the first position where the reading device 100 faces the conveying path 4 as illustrated in FIG. 2.

When the original G that is being conveyed along the conveying path 4 passes the position facing the reading device 100 that is at the first position, the reading device 100 reads the image information on the first side of the original G. The image information on the first side of the original G thus read is transmitted to the image control unit C.

The original G that has passed the position facing the reading device 100 is further conveyed along the conveying path 5 by the conveying rollers 70 and 71. In this step, the flapper 200 is at a position 200b. Therefore, the original G is guided to the second original-conveying path 6 by the flapper 200 and is conveyed along the second original-conveying path 6 by the conveying rollers 72 and 74 until the trailing end of the original G passes the flapper 200. Subsequently, the conveying rollers 72 and 74 rotate backward, whereby the original G is switched back (reversely conveyed). In this step, the flapper 200 moves to the position 200a illustrated in FIG. 1 and guides the original G to the second original-conveying path 7.

Meanwhile, the reading device 100 that has read the first side of the original G moves to the second position facing the second original-conveying path 7 by rotating counterclockwise in FIG. 1 before the original G reaches a position of the second original-conveying path 7 that faces the reading device 100. The axis of rotation of the reading device 100 extends parallel to the first side and the second side, corresponding to the back side, of the original G at the position facing the reading device 100 and is orthogonal to the direction of conveyance of the original G passing the position facing the reading device 100.

When the original G that is being conveyed along the second original-conveying path 7 passes the position facing the reading device 100 that is at the second position, the reading device 100 reads the image information on the second side of the original G. The image information on the second side of the original G thus read is transmitted to the image control unit C. The original G that has undergone the reading of the first side and the second side thereof is conveyed by the conveying rollers 70 and 78 and the conveying rollers 43a and 43b, is discharged to the outside of the apparatus 1, and is stacked on the second discharge portion 82. In this manner, the two sides (the first side and the second side) of the original G are read by one reading device 100.

Now, an operation of forming an image on a recording material S on the basis of the image information that has been read from the original G will be described.

While the second side of the original G that is being conveyed along the second original-conveying path 7 is read, a recording material S is fed from the first feed unit 30 as described in the above description of the image forming operation. Substantially simultaneously, a latent image corresponding to the above image information is formed on the photoconductor drum 10 by the light-emitting portion 21 on the basis of the information on the second side of the original G that has been stored in the memory included in the image control unit C. Furthermore, the latent image is developed into a toner image corresponding to the latent image by the developing roller 11. Subsequently, the toner image is transferred to the front side of the recording material S at the transfer nip between the photoconductor drum 10 and the transfer roller 15, and the recording material S is conveyed to the fixing portion 50, where the toner image is fixed. Thus, the formation of an image corresponding to the second side of the original G on the front side of the recording material S is complete.

In the above case, the feeding of the recording material S is started with the start of the reading of the information on the second side of the original G. Alternatively, the feeding of the recording material S may be started after the completion of the reading of the information on the second side of the original G.

The recording material S that has undergone the formation of the image corresponding to the second side of the original G is switched back with the backward rotation of the discharge rollers 60a and 60b, is conveyed toward the conveying paths 4 and 5, and is further conveyed to the transfer nip between the photoconductor drum 10 and the transfer roller 15 again. Subsequently, on the basis of the image information on the first side of the original G that is stored in the memory included in the image control unit C, an image corresponding to the first side of the original G is transferred to the back side of the recording material S. Then, the recording material S is conveyed through the fixing portion 50 and is discharged to the first discharge portion 40.

The reading device 100 is rotatable and thus movable among the first position, the second position, and the third position. During such a movement, any of the elements included in the reading device 100 such as the glass plate 110 may interfere with portions of any of guide members defining the conveying path 4 and the second original-conveying path 7 that reside near the reading device 100. In such a case, the movement of the reading device 100 may be hindered, or the reading device 100, the glass plate 110, and the guide members may be damaged. Therefore, in the first embodiment, the glass plate 110 is retracted when the reading device 100 is rotated. Such a configuration and an operation of the reading device 100 will now be described.

### Configuration of Reading Device 100

The configuration of the reading device 100 will now be described. FIG. 3 is an exploded perspective view of the reading device (the reading unit) 100. The reading device 100 basically includes a sensor unit 120 and a rotation guide 130. The sensor unit 120 includes a sensor member 121 and the glass plate 110. The sensor member 121 includes a light-emitting portion configured to emit light toward the original G, and a plurality of solid-state image pickup elements (forming a line sensor) aligned in the longitudinal direction of the sensor unit 120. The glass plate 110 has a long shape that covers the sensor member 121. Light is applied from the light-emitting portion of the sensor member 121 to the original G through the glass plate 110, and the reflection from the original G transmitted through the glass plate 110 is received by the plurality of solid-state image pickup elements included in the sensor member 121, whereby the image on the original G is read. The surface of the glass plate 110 serves as a reading surface with which the reading device 100 performs reading. Each portion of the image on the original G that comes to face the reading surface is read by the reading device 100 through the reading surface. The sensor unit 120 has a boss 120a and a boss 120b that are provided at each of two longitudinal ends thereof (in FIG. 3, only the bosses 120a and 120b provided on the near side are illustrated while those on the far side are hidden). The bosses 120a and 120b are fitted in and held by a corresponding one of slits 130c and 130d that are provided at two respective longitudinal ends of the rotation guide 130. The rotation guide 130 has rotation center portions 130a and 130b that are provided on the axis of rotation X. The rotation guide 130 is rotatable about the axis of rotation X. The rotation guide 130 houses springs (compression springs) 150 as elastic members and pressing plates 140 as pressing members that press the sensor unit 120. Hence, the rotation guide 130 presses the two longitudinal ends of the sensor unit 120 in a direction of arrow A with the aid of the springs 150 and the pressing plates 140.

With such a configuration, the sensor unit 120 that is pressed by the springs 150 is guided along the slits 130c and 130d and is thus slidably held by the rotation guide 130 serving as a holding member. Therefore, the sensor unit 120 is movable with respect to the rotation guide 130 in the longitudinal direction of the slits 130c and 130d (in the direction orthogonal to the axis of rotation X) while being rotatable together with the rotation guide 130.

### Mechanism of Holding Reading Device 100

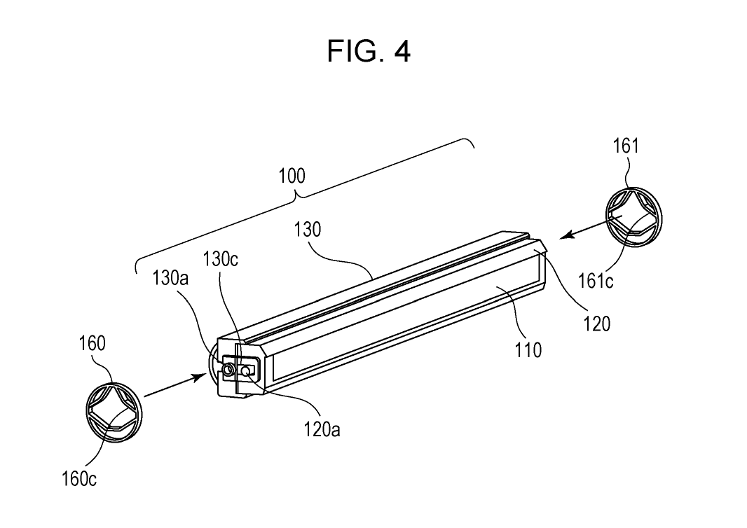

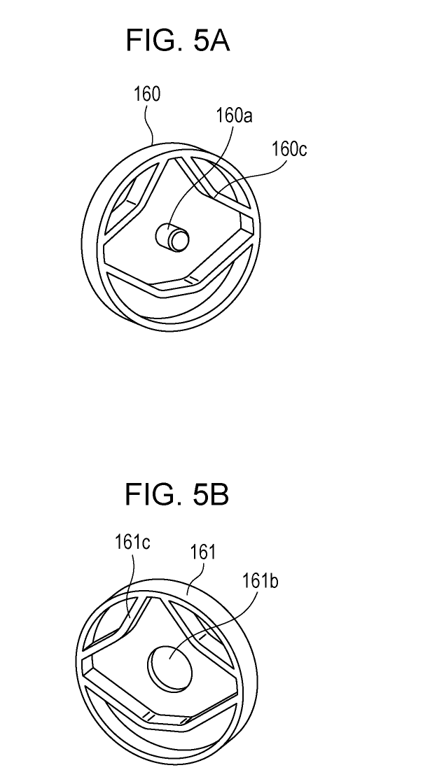

Now, a mechanism of holding the reading device 100 will be described with reference to FIGS. 4, 5A, 5B, and 6. FIG. 4 is a perspective view of the mechanism of holding the reading device 100. FIGS. 5A and 5B are perspective views of cam members 160 and 161, respectively. For easy illustration, some parts of the cam members 160 and 161 are omitted in FIG. 4. The omitted parts are illustrated in detail in FIGS. 5A and 5B. Hence, the cam members 160 and 161 will be described with reference to FIGS. 4, 5A, and 5B. FIG. 6 is a sectional view of part of the apparatus 1 illustrating the reading device 100 and peripheral elements.

As illustrated in FIG. 4, the rotation center portions 130a and 130b (the rotation center portion 130b is hidden) provided at the two respective ends of the rotation guide 130 are rotatably held by the respective cam members 160 and 161, which are fixed to a frame (not illustrated) of the main body of the apparatus 1. The rotation center portion 130a is provided in the form of a hole, in which a boss 160a provided at the center of the cam member 160, which serves as a regulating member, illustrated in FIG. 5A is fitted, whereby the rotation guide 130 is held in such a manner as to be rotatable with respect to the cam member 160. The rotation center portion 130b is provided in the form of a boss, which is fitted in a hole 161b provided at the center of the cam member 161 illustrated in FIG. 5B, whereby the rotation guide 130 is held in such a manner as to be rotatable with respect to the cam member 161.

The boss 120a provided on the side of the cam member 160 is positioned on the inner side of a cam surface 160c of the cam member 160 (between the cam surface 160c and the boss 160a). Likewise, the boss 120a provided on the side of the cam member 161 is positioned on the inner side of a cam surface 161c of the cam member 161 (between the cam surface 161c and the hole 161b). Therefore, the bosses 120a come into contact with the respective cam surfaces 160c and 161c depending on the phase of rotation of the reading device 100, whereby the position of the sensor unit 120 in the radial direction with respect to the rotation center portions 130a and 130b is regulated. That is, when the reading device 100 rotates, the bosses 120a are pushed by the respective cam surfaces 160c and 161c and move along the respective slits 130c and 130d toward the center of rotation (the rotation center portions 130a and 130b). Simultaneously, the sensor unit 120 also moves toward the center of rotation (the rotation center portions 130a and 130b).

As illustrated in FIG. 6, in the apparatus 1, conveyance guides (first guide members) 410, 411, and 425 that guide the recording material S or the original G and the conveying rollers 70 and 71 are provided in the conveying path 4 on the upstream side with respect to the reading device 100. Furthermore, conveyance guides (first guide members) 412 and 413 are provided in the conveying path 4 on the downstream side with respect to the reading device 100. The conveyance guide 410 includes a counter guide portion 415 that faces the reading device 100.

Conveyance guides (second guide members) 710 and 711 and conveying rollers 76 and 77 are provided in the second original-conveying path 7 on the upstream side with respect to the reading device 100. Furthermore, the conveying rollers 70 and 78 and conveyance guides (second guide members) 712 and 713 are provided in the second original-conveying path 7 on the downstream side with respect to the reading device 100. The conveyance guide 711 includes a counter guide portion 435 that faces the reading device 100. The white reference portion 170 is provided above the reading device 100. The conveyance guide 410, the conveyance guide 711, and the white reference portion 170 each serve as a facing member that includes a portion (the counter guide portion 415, the counter guide portion 435, or the like) that faces the front surface of the glass plate 110. The front surface of the glass plate 110 forms the reading surface of the reading device 100.

The conveyance guides 410, 411, 425, 412, 413, 710, 711, 712, and 713, the white reference portion 170, and the cam members 160 and 161 are fixed to the frame (not illustrated) of the apparatus 1.

The rotation center portions 130a and 130b provided at the two respective ends of the rotation guide 130 included in the reading device 100 are rotatably supported on the axis of rotation X by the boss 160a of the cam member 160 and the hole 161b of the cam member 161. Hence, in FIG. 6, the foregoing elements excluding the axis of rotation X are not illustrated. The rotation guide 130 is rotatable about the axis of rotation X by receiving a driving force from a driving source (not illustrated).

In FIG. 6, the reading device 100 is at the first position with the glass plate 110 facing the counter guide portion 415, and is ready for reading an image on an original G that is conveyed along the conveying path 4. If the rotation guide 130 in this state is rotated counterclockwise by 90 degrees about the axis of rotation X by the driving source (not illustrated), the reading device 100 moves to the third position for reading the white reference portion 170 where the glass plate 110 faces the white reference portion 170. If the rotation guide 130 of the reading device 100 that is at the first position is rotated counterclockwise by 180 degrees about the axis of rotation X by the driving source (not illustrated), the reading device 100 moves to the second position where the glass plate 110 faces the counter guide portion 435. The reading device 100 that is at the second position reads an image on an original G that is conveyed along the second original-conveying path 7.

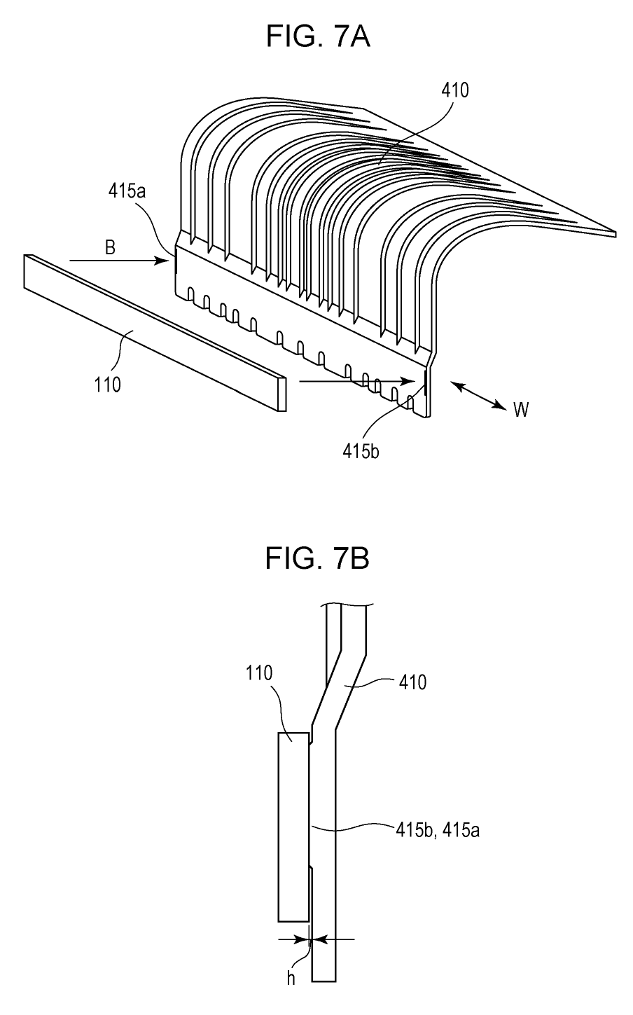

Now, the relationship between the conveyance guide 410 and the reading device 100 will be described with reference to FIGS. 7A and 7B.

The sensor unit 120 included in the reading device 100 is a contact image sensor (CIS) and is therefore of a small size with a small depth of field. Hence, the distance (gap) between the glass plate 110 of the sensor unit 120 and the counter guide portion 415 needs to be small. However, if an original G such as a flexible thin paper is conveyed in a case where the gap is too small, the original G may buckle when passing through the gap between the glass plate 110 of the sensor unit 120 and the counter guide portion 415. Such buckling may cause conveyance failure such as significant changes in the speed of the original G, a jam, or the like during the image reading operation, failing in correct reading of the image.

Accordingly, in the first embodiment, the position of the glass plate 110 is regulated such that the distance between the counter guide portion 415 of the conveyance guide 410 and the glass plate 110 does not become smaller than a predetermined value. FIG. 7A is a perspective view of the conveyance guide 410. FIG. 7B is a sectional view of a portion of the conveyance guide 410 that is near the glass plate 110 and is seen in the width direction of the original G (a direction of arrow W).

The conveyance guide 410 has ribs 415a and 415b provided on the outer side of the respective ends, in the direction of arrow W (the width direction), of a region of the counter guide portion 415 within which the original G is conveyed. The glass plate 110 comes into contact with the ribs 415a and 415b in a direction of arrow B. In a state where the glass plate 110 is in contact with the ribs 415a and 415b in the direction of arrow B as illustrated in FIG. 7B, a gap h corresponding to the height of the ribs 415a and 415b in the direction of arrow B is provided between the counter guide portion 415 and the glass plate 110. With such a gap, the pressure to be applied to the original G in the direction of arrow B is reduced, lowering the probability of the occurrence of buckling of the original G.

The counter guide portion 435 of the conveyance guide 711 also has ribs similar to the ribs 415a and 415b. Such a mechanism of regulating the position of the glass plate 110 is not limited to the ribs provided on the counter guide portions 415 and 435. The reading device 100 may have contact portions such as ribs that project with respect to the glass plate 110 in such a manner as to come into contact with the counter guide portion 415 or 435.

### Rotational Movement of Reading Device 100

The movement of the sensor unit 120 when the reading device 100 rotates will now be described. When the reading device 100 is at the first position as illustrated in FIG. 6, a distance r between the axis of rotation X of the cam member 160 and an observation point 110p defined at a predetermined position on the surface of the glass plate 110 is r1, which is the maximum value.

When the rotation guide 130 is rotated counterclockwise about the axis of rotation X by the driving source (not illustrated), the boss 120a is pushed by the sidewalls of the slit 130c, whereby the sensor unit 120 rotates together with the rotation guide 130. Furthermore, the boss 120a comes into contact with the cam surface 160c and is pushed in the radial direction with respect to the axis of rotation X in such a manner as to move toward the axis of rotation X.

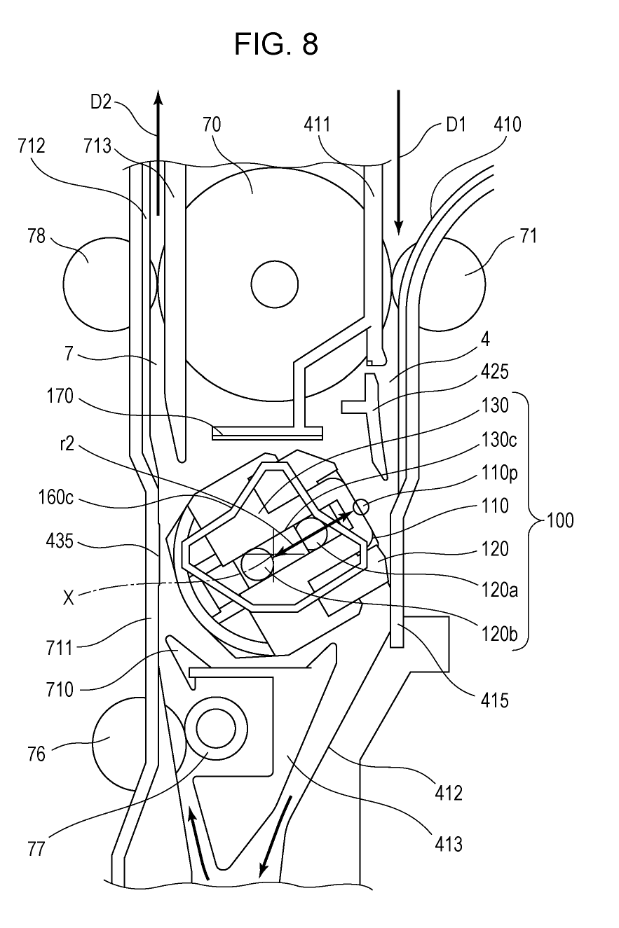

FIG. 8 is a sectional view of part of the reading device 100 and peripheral elements that are in a state after the rotation guide 130 that has been in the state illustrated in FIG. 6 is rotated counterclockwise by 30 degrees. In this state, the boss 120a is in contact with the cam surface 160c, and is nearer to the axis of rotation X than in the state illustrated in FIG. 6. The distance r between the axis of rotation X and the observation point 110p is r2 (<r1). The relationship between the cam surface 160c and the boss 120a also applies to the relationship between the cam surface 161c and the other boss 120a.

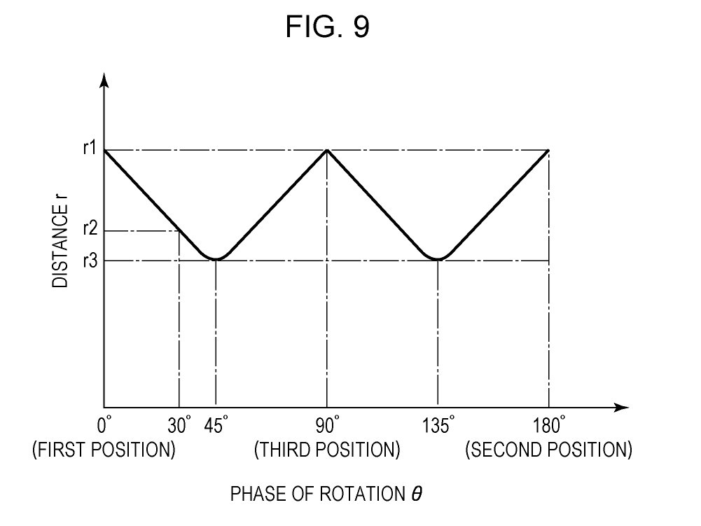

FIG. 9 is a graph illustrating the change in the distance r between the observation point 110p (a predetermined point on the reading device 100), which is a representative point on the glass plate 110, and the axis of rotation X that occurs with the change in the phase of rotation θ of the reading device 100. The first position corresponds to 0 degrees, which is defined as the reference. The position taken after the rotation by 180 degrees from the first position corresponds to the second position. As described above, the positions of the bosses 120a are regulated by the respective cam surfaces 160c and 161c that come into contact therewith. Hence, the distance r changes with the phase of rotation θ of the reading device 100. When the phase of rotation θ is 0, 90, or 180 degrees, the distance r is r1. In this state, the observation point 110p is farthest from the axis of rotation X. When the phase of rotation θ is 45 or 135 degrees, the distance r is r3 (<r2). In this state, the observation point 110p is nearest to the axis of rotation X.

By regulating the positions of the bosses 120a as described above, when the reading device 100 is rotated from the first position, the sensor unit 120 including the glass plate 110 is retracted (moved away and spaced apart) from the counter guide portion 415 of the conveyance guide 410 and the conveyance guide 425 that are provided near the reading device 100, and is thus prevented from interfering (colliding) with the counter guide portion 415 and the conveyance guide 425. As can be seen from FIG. 9, when the reading device 100 is rotated from the second position or the third position also, the sensor unit 120 including the glass plate 110 is retracted from the counter guide portion 435 of the conveyance guide 711, the conveyance guide 713, and the white reference portion 170 that are provided near the reading device 100, and is thus prevented from interfering with the counter guide portion 435, the conveyance guide 713, and the white reference portion 170. The above elements that are provided near the reading device 100 correspond to elements that may interfere with the reading device 100 if the reading device 100 that is at the first, second, or third position is rotated without being retracted in the radial direction with respect to the axis of rotation X. More specifically, the elements correspond to portions that are on the locus (including tolerances) of rotation of the reading device 100 if the reading device 100 that is at the first, second, or third position is rotated without being retracted in the radial direction with respect to the axis of rotation X.

If the distance r is smaller than r1, it is regarded that the sensor unit 120 is at a retracted position that is retracted from the guide members provided near the reading device 100.

Referring to FIG. 6, if it is attempted to rotate the reading device 100 that is at the first position in the clockwise direction, the boss 120a comes into contact with the cam surface 160c in a direction of arrow D1, which corresponds to the direction of conveyance of the original G. Hence, if the reading device 100 is slightly rotated clockwise while being dragged by a frictional force occurring between the reading device 100 and the original G when the reading device 100 that is at the first position reads an image on the original G, the boss 120a comes into contact with the cam surface 160c in the direction of arrow D1, whereby the dragging is stopped. In this manner, the cam member 160 also serves as a regulating member that is capable of regulating the rotation of the reading device 100. Such a mechanism also applies to the reading device 100 that is at the second or third position. For example, at the second position, the original G is conveyed in a direction of arrow D2, and the dragging of the reading device 100 in the direction of arrow D2 is stopped.

To produce the above effect of preventing the interference, the cam surfaces 160c and 161c are not necessarily constantly in contact with the respective bosses 120a. In the first embodiment, when the phase of rotation θ of the reading device 100 is 0, 90, or 180 degrees, the bosses 120a are each held between portions of a corresponding one of the cam surfaces 160c and 161c with a small gap interposed therebetween in the circumferential direction about the axis of rotation X. Hence, when the phase of rotation θ of the reading device 100 is 0, 90, or 180 degrees, the positions of the bosses 120a in the radial direction with respect to the axis of rotation X are not regulated by the respective cam surfaces 160c and 161c. When the reading device 100 is rotated clockwise or counterclockwise, the positions of the bosses 120a in the radial direction start to be regulated by the respective cam surfaces 160c and 161c. In the first embodiment, when the phase of rotation θ of the reading device 100 is 0, 90, or 180 degrees, the ribs 415a and 415b and like elements described above come into contact with the glass plate 110. Thus, the position of the sensor unit 120 in the radial direction with respect to the axis of rotation X is regulated. In this manner, the above effect of preventing the interference is produced as long as the positions of the bosses 120a are regulated by the respective cam surfaces 160c and 161c at least when the reading device 100 is at any phase of rotation θ where the reading device 100 may interfere with the conveyance guides or other elements when being rotated.

As described above, according to the first embodiment, the interference between the reading device 100 and the guide members that may occur when the reading device 100 is moved is prevented.

### Second Embodiment

In the first embodiment, the sensor unit 120 of the reading device 100 is retractable from the conveyance guides. In a second embodiment, conveyance guides are retractable from a sensor unit 120 of a reading device 100. Such a configuration according to the second embodiment will now be described. Elements the same as those described in the first embodiment are denoted by corresponding ones of the reference numerals used in the first embodiment, and description thereof is omitted.

### Configuration of Reading Device 100

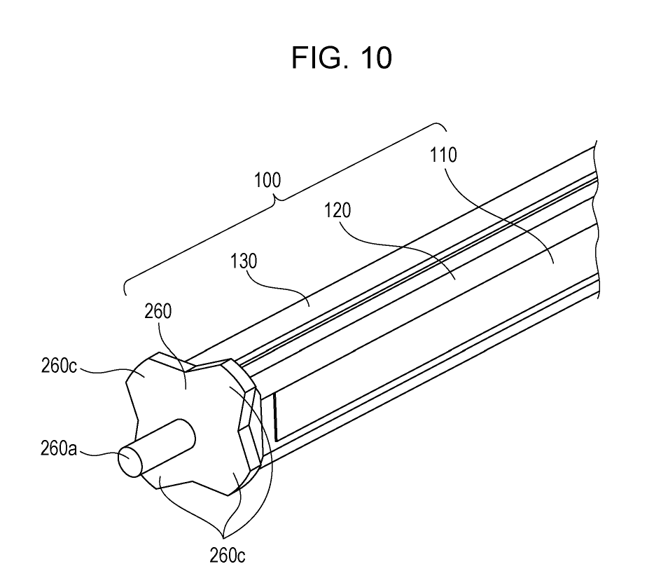

FIG. 10 is a perspective view illustrating part of the reading device 100. The reading device 100 includes a sensor unit 120 including a glass plate 110, a rotation guide 130 to which the sensor unit 120 is fixed, and cam members 260 serving as regulating members and fixed at two respective ends of the rotation guide 130. In the first embodiment, the sensor unit 120 is movable with respect to the rotation guide 130 in the radial direction with respect to the axis of rotation X. In the second embodiment, the sensor unit 120 is fixed. The cam members 260 each include a rotational shaft 260a that is rotatably supported by the frame (not illustrated) of the apparatus 1, whereby the sensor unit 120 is rotatable about the axis of rotation X. Each of the cam members 260 has four projections 260c arranged at intervals of 90 degrees about the rotational shaft 260a.

### Rotational Movement of Reading Device 100

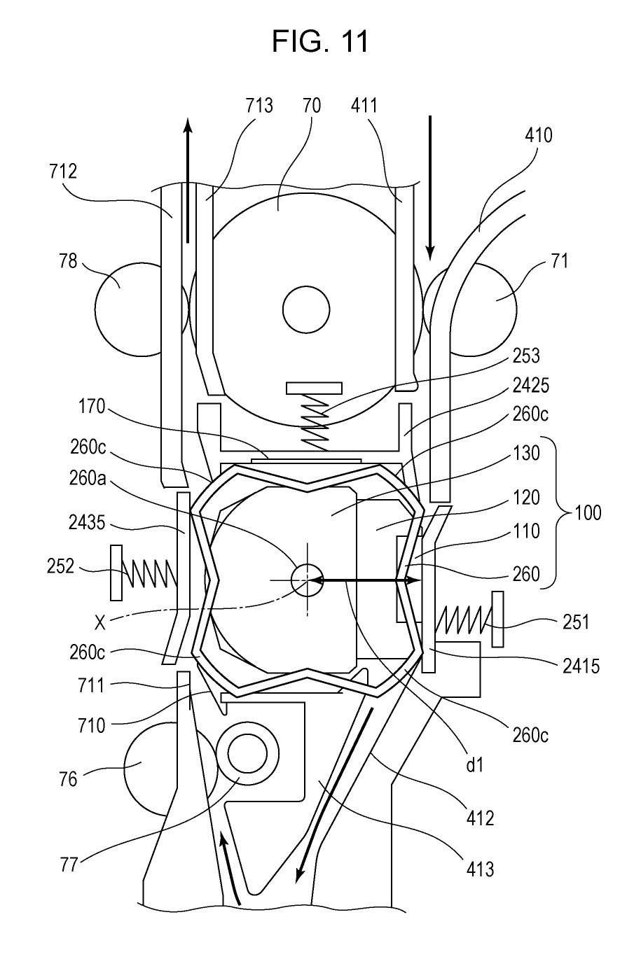

FIG. 11 is a sectional view of part of the apparatus 1 illustrating the reading device 100 and peripheral elements. A movable guide (first guide member) 2415 is provided at a position that is to face the glass plate 110 when the reading device 100 is at the first position for reading an original G that is conveyed along the conveying path 4. The movable guide 2415 is urged in a direction toward the glass plate 110 (a direction toward the axis of rotation X) by a spring 251 serving as an elastic member. Another movable guide 2435 is provided at a position that is to face the glass plate 110 when the reading device 100 is at the second position for reading an original G that is conveyed along the second original-conveying path 7. The movable guide 2435 is urged in the direction toward the glass plate 110 (the direction toward the axis of rotation X) by a spring 252 serving as an elastic member.

Yet another movable guide 2425 (a second guide member) is provided at a position that is to face the glass plate 110 when the reading device 100 is at the third position for reading the white reference portion 170. The movable guide 2425 is urged in the direction toward the glass plate 110 (the direction toward the axis of rotation X) by a spring 253 serving as an elastic member. The white reference portion 170 is provided on the movable guide 2425.

The movable guides 2415, 2435, and 2425 are guide members provided near the reading device 100 and that may interfere with the reading device 100 unless they are retracted from the reading device 100 when the reading device 100 is rotated.

The movable guides 2415, 2435, and 2425 each have, at two respective ends thereof, ribs that are similar to the ribs 415a and 415b described in the first embodiment. When the glass plate 110 is at a position facing any of the movable guides 2415, 2435, and 2425, the ribs are in contact with the glass plate 110, whereby the distance between the movable guide 2415, 2435, or 2425 and the glass plate 110 is determined.

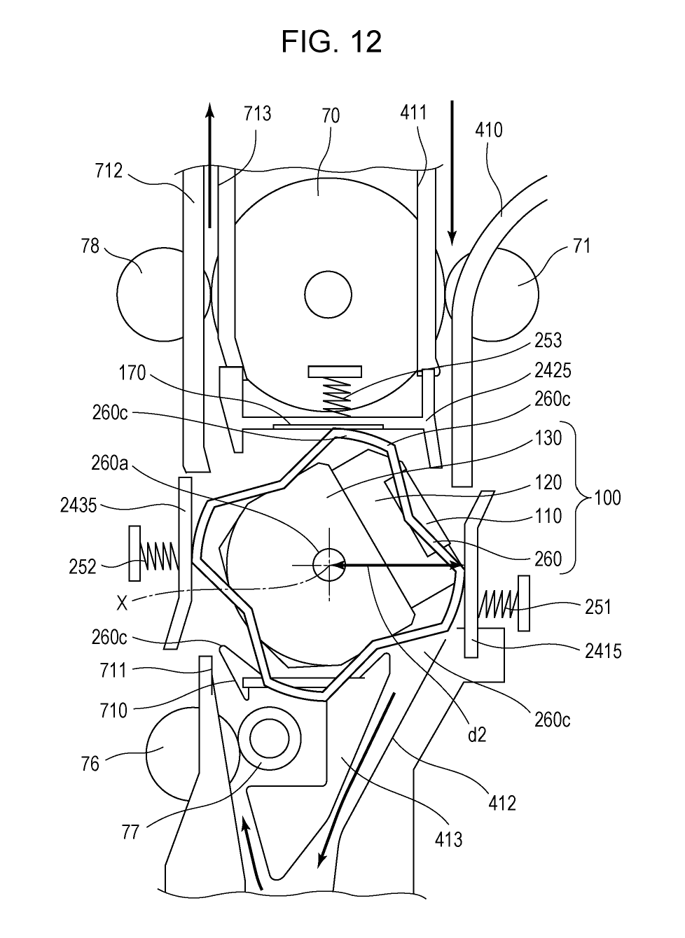

In the state illustrated in FIG. 11, the reading device 100 is at the first position, and the glass plate 110 faces the movable guide 2415. A distance d between the axis of rotation X and the movable guide 2415 in this state is d1. When the reading device 100 in this state is rotated counterclockwise by 30 degrees, the reading device 100 moves to a position illustrated in FIG. 12. Since the cam members 260 rotate together with the sensor unit 120, the movable guide 2415 is pushed by one of the projections 260c of each of the cam members 260. Consequently, the distance d between the axis of rotation X and the movable guide 2415 becomes d2 (>d1).

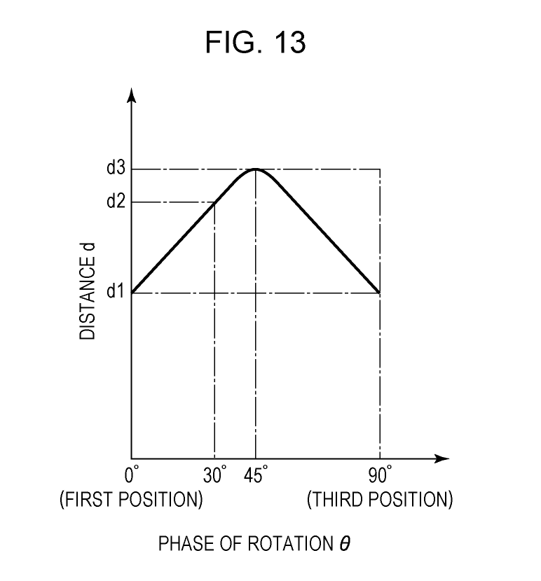

FIG. 13 is a graph illustrating the change in the distance d between the movable guide 2415 and the axis of rotation X that occurs with the change in the phase of rotation θ of the reading device 100. The first position corresponds to 0 degrees, which is the reference. The position taken after the rotation by 90 degrees from the first position corresponds to the third position. As described above, since the position of the movable guide 2415 is regulated by the cam members 260, the distance d changes with the phase of rotation θ of the reading device 100. When the phase of rotation θ is 0 or 90 degrees, d=d1 and the movable guide 2415 is positioned nearest to the axis of rotation X. When the phase of rotation θ is 45 degrees, d=d3 (>d2) and the movable guide 2415 is positioned farthest from the axis of rotation X.

In this manner, since the movable guide 2415 is pushed by one of the projections 260c of each of the cam members 260 so that the position of the movable guide 2415 in the direction toward the axis of rotation X is regulated, the movable guide 2415 is prevented from interfering with the glass plate 110 by being retracted from the glass plate 110 (by being moved to the retracted position). Likewise, since the other movable guides 2435 and 2425 are each configured to be pushed by one of the projections 260c of each of the cam members 260, the movable guides 2435 and 2425 are prevented from interfering with the glass plate 110 by being retracted from the glass plate 110 (by being moved to the retracted position).

If the reading device 100 that is at the first position or the second position is slightly rotated, one of the projections 260c of each of the cam members 260 that rotate together with the reading device 100 comes into contact with the movable guide 2415 or 2435. Hence, the rotation of the reading device 100 is stopped. Thus, as in the first embodiment, the reading device 100 is prevented from being dragged by the original G or the like that is conveyed.

Although the cam members 260 according to the second embodiment each have four projections 260c, each of the cam members 260 only needs to have at least two projections 260c that are provided on both sides, respectively, of the reading device 100 so that the interference between the glass plate 110 and the movable guides is avoided. Moreover, the cam members 260 only need to be capable of regulating the positions of the movable guides in accordance with the phase of rotation of the reading device 100 and thus retracting the movable guides from the reading device 100. The cam members 260 may be rotatable about an axis different from the axis of rotation X, or may be movable back and forth.

As described above, according to the second embodiment, the interference between any of the guide members and the reading device 100 or the portion of the reading device 100 that faces the original G that may occur when the reading device 100 is moved is prevented as in the first embodiment.

While the image forming section according to each of the first and second embodiments is of an electrophotographic type, the image forming section may be of any other recording type such as an inkjet type.

### Third Embodiment

In the first embodiment, when the reading device 100 is rotated, the bosses 120a of the sensor unit 120 are pushed by the cam surfaces 160c and 161c of the cam members 160 and 161, whereby the sensor unit 120 is retracted. In a third embodiment, the sensor unit 120 is retracted independently of the rotation of the reading device 100. Such a configuration will now be described. Elements the same as those described in the first embodiment are denoted by corresponding ones of the reference numerals used in the first embodiment, and description thereof is omitted.

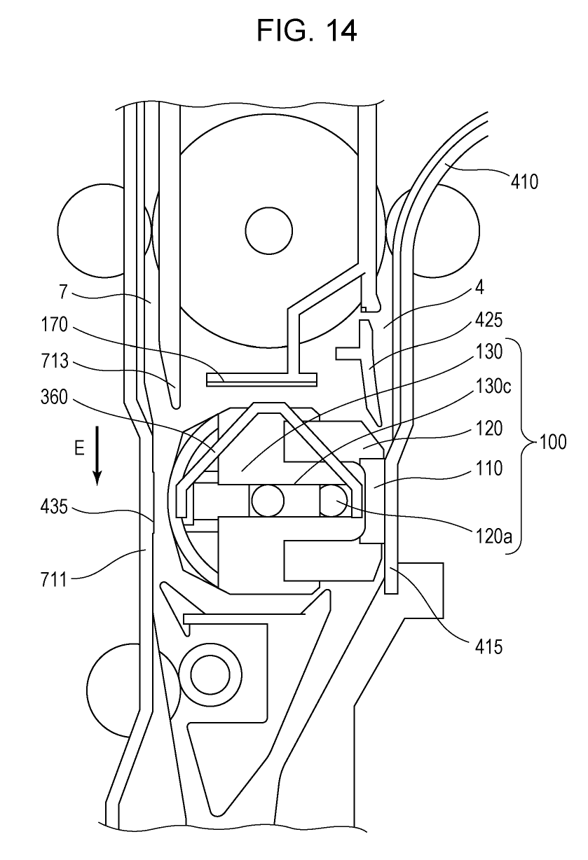

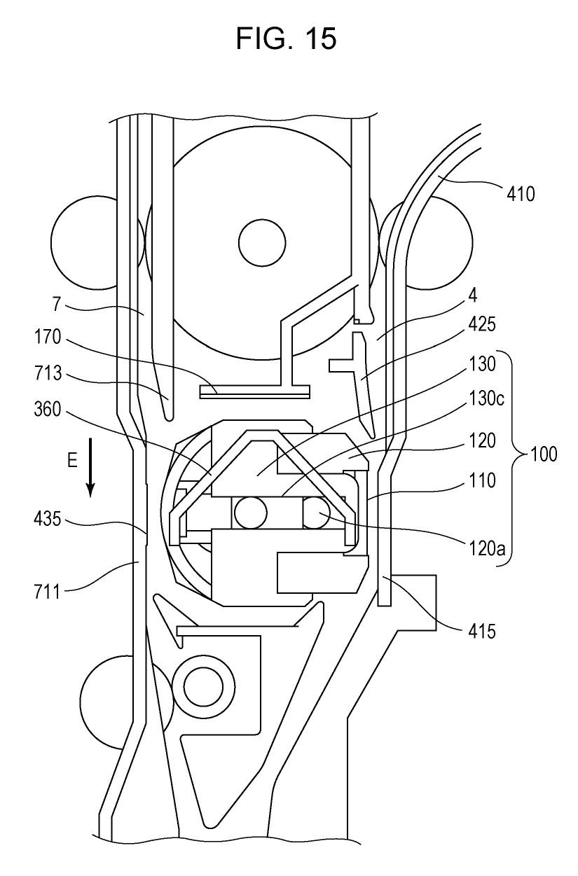

FIGS. 14 and 15 are sectional views illustrating the reading device 100 and peripheral elements. In the third embodiment, the cam members 160 and 161 according to the first embodiment that are fixed to the frame (not illustrated) of the main body of the apparatus 1 are replaced with cam members 360 that are each movable in a direction of arrow E by a solenoid (not illustrated) serving as a driving device. As illustrated in FIG. 15, when the cam members 360 are moved in the direction of arrow E, the cam members 360 pushes the respective bosses 120a of the sensor unit 120 of the reading device 100 that is at the first position. Since the cam members 360 push the bosses 120a, the sensor unit 120 is retracted from the conveyance guide 410 including the counter guide portion 415 and the conveyance guide 425. Even if the reading device 100 in this state is rotated, the interference between the sensor unit 120 and the conveyance guide 410 including the counter guide portion 415 and the conveyance guide 425 is prevented.

When the reading device 100 is at the second or third position, the cam members 360 are also moved in the direction of arrow E, whereby the sensor unit 120 is retracted from the conveyance guide 711 including the counter guide portion 435, the conveyance guide 713, and the white reference portion 170.

Thus, even if the sensor unit 120 is retracted before the reading device 100 is rotated, the interference between the reading device 100 and the guide members that may occur when the reading device 100 is moved is prevented as in the first embodiment. That is, as long as one of the reading device 100 and any of the guide members is retracted from the other before the reading device 100 and the guide member interfere with each other, the reading device 100 or the guiding member may be retracted either during the rotation of the reading device 100 or before the rotation of the reading device 100.

The configuration according to the third embodiment where the sensor unit 120 is retracted independently of the rotation of the reading device 100 also applies to the second embodiment where the movable guides 2415, 2435, and 2425 are retractable. That is, instead of the cam members 260, other cam members that retract the movable guides 2415, 2435, and 2425 from the sensor unit 120 may be provided, and the cam members may each be moved by a driving device that is capable of driving the cam members independently of the rotation of the reading device 100. Thus, the same effect as in the second embodiment is produced.

The first and third embodiments each concern a case where the reading device 100 is retractable from the guide members. The second embodiment concerns a case where the guide members are retractable from the reading device 100. Alternatively, both the reading device and the guide members may be moved (retracted) away from each other when the reading device is rotated.

### Fourth Embodiment

A fourth embodiment will now be described. In a configuration in which a portion of a duplex conveying path for forming images on both sides of a recording material is shared with a conveying path for conveying an original that is to be read by a reading device, the recording material (a sheet) that has been heated by passing through a fixing device may pass through a position facing the reading device. If such a heated recording material is conveyed along the shared portion of the conveying path and passes through the position facing the reading device, the heat of the recording material may raise the temperatures of a light source, imaging elements, and sensors (image pickup elements) that are provided in the reading device, resulting in deterioration in the reading accuracy of the recording unit or damage to the reading device. The fourth embodiment concerns a configuration that suppresses the deterioration in the reading accuracy of the reading device and the damage to the reading device that may be caused by the rise of the temperature of the reading device due to the heat of the recording material. An image forming apparatus 1 according to the fourth embodiment basically has the same configuration as the image reading apparatus 1 according to any of the first to third embodiments and has a function of an image reading apparatus. Hence, the image forming apparatus 1 is also regarded as an image reading apparatus. Therefore, elements the same as those described in any of the first to third embodiments are denoted by corresponding ones of the reference numerals used in the first to third embodiments, and description thereof is omitted.

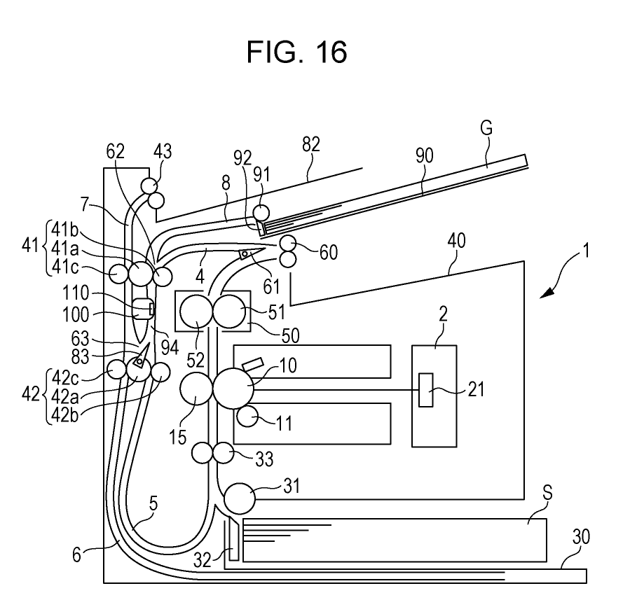

Referring to FIGS. 16 to 18B, the image forming apparatus 1 according to the fourth embodiment will now be described. FIG. 16 is a schematic sectional view of the image forming apparatus 1 (hereinafter simply referred to as apparatus 1). The apparatus 1 includes an image forming section. The image forming section performs a known electrophotographic image forming process, thereby forming a toner image on a recording material S. The image forming section includes a rotatable photoconductor drum 10 serving as an image carrying member. The image forming section further includes, around the photoconductor drum 10, a charging unit (not illustrated), an optical unit 2 serving as an exposure unit, a developing roller 11 serving as a developing unit, a transfer roller 15 serving as a transfer unit, and a fixing portion 50 including a heat roller 51 and a pressure roller 52.

### Image Forming Process

The image forming process performed by the image forming section will now be described. When the image forming section receives a print signal, a light-emitting portion 21 included in the optical unit 2 emits laser light generated on the basis of information on an image to be formed on the surface of the photoconductor drum 10 that has been charged by the charging unit (not illustrated). Thus, a latent image formed of electrical charges is formed on the surface of the photoconductor drum 10 that is in rotation. Subsequently, the developing roller 11 that is in rotation while carrying toner supplies the toner to the latent image on the surface of the photoconductor drum 10, whereby a toner image is formed on the surface of the photoconductor drum 10.

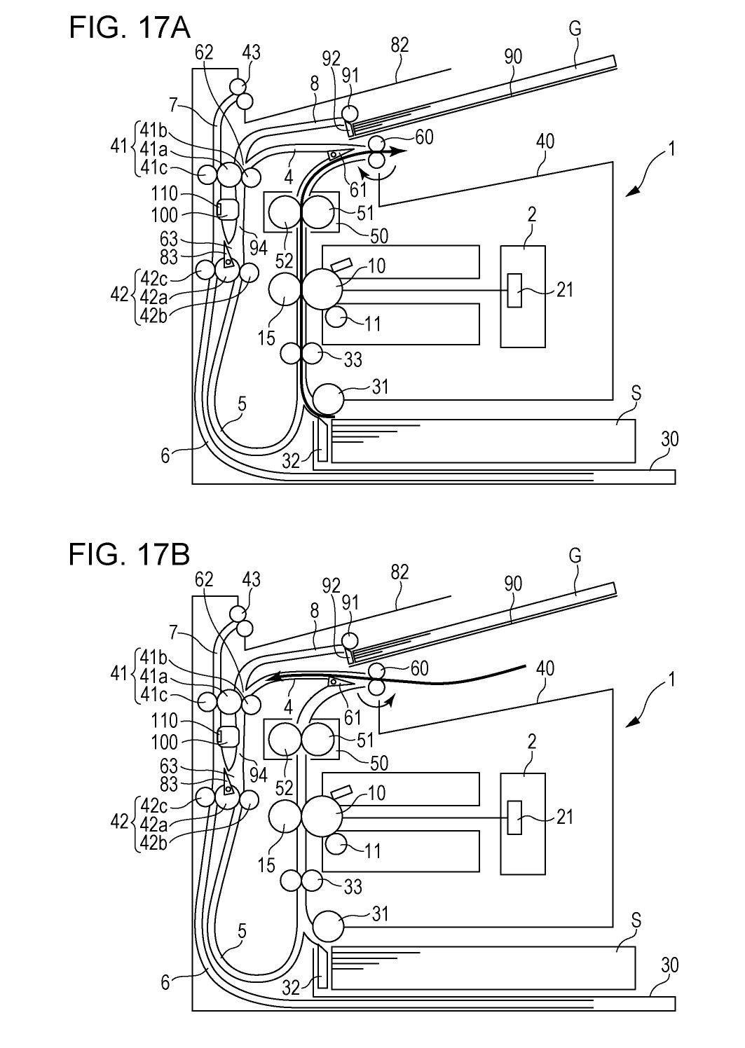

Meanwhile, referring to FIG. 17A, recording materials S stored in a first feed unit 30 are each fed by a pickup roller 31 and a separating member 32, and the thus fed recording material S is conveyed to a pair of conveying rollers 33. The pair of conveying rollers 33 convey the recording material S to a transfer nip (transfer portion) between the photoconductor drum 10 and the transfer roller 15 at such a timing that the leading end of the toner image on the surface of the photoconductor drum 10 and the leading end of the recording material S meet each other. The toner image thus conveyed to the transfer nip with the rotation of the photoconductor drum 10 is transferred to a first side of the recording material S with a transfer bias applied to the transfer roller 15 and a pressure produced between the photoconductor drum 10 and the transfer roller 15. Subsequently, the recording material S having the toner image transferred thereto is conveyed to a fixing nip (fixing part) formed between the heat roller 51 and the pressure roller 52 included in the fixing portion 50. The toner image on the recording material S is fixed to the first side of the recording material S with heat applied thereto from the heat roller 51 and a pressure produced between the heat roller 51 and the pressure roller 52. The recording material S that has passed through the fixing portion 50 is conveyed by a pair of discharge rollers 60.

In a case of simplex printing, the pair of discharge rollers 60 convey the recording material S directly to the outside of the apparatus 1, and the recording material S is discharged onto a first discharge portion 40. Thus, the image forming process in the case of simplex printing is complete.

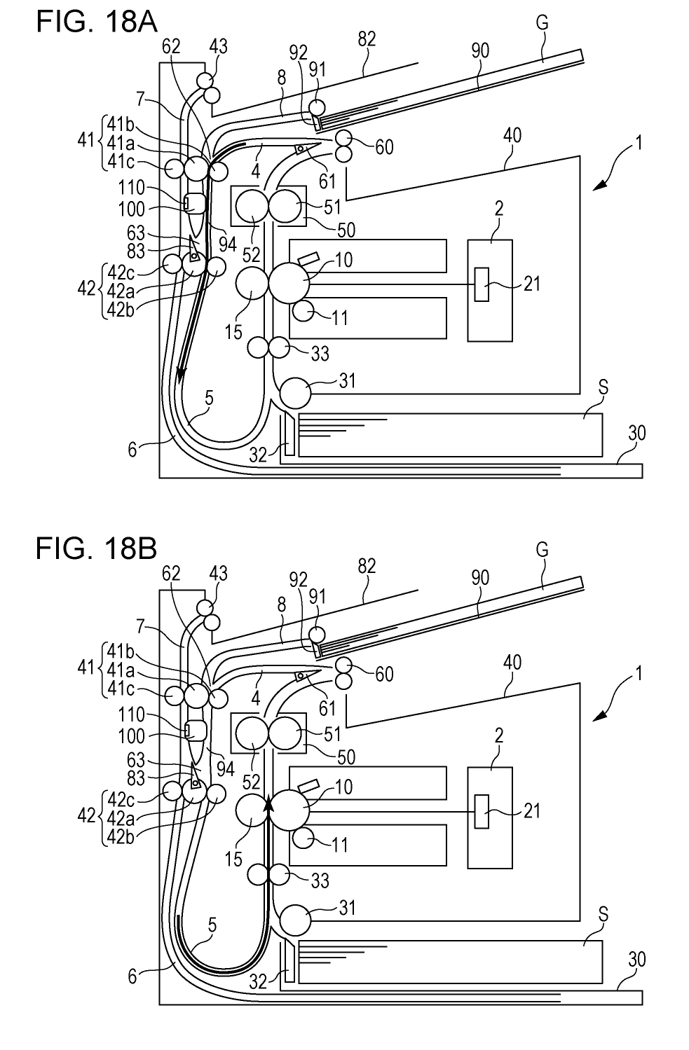

In a case of duplex printing, the recording material S having the toner image fixed to the first side thereof is also conveyed by the pair of discharge rollers 60. When the trailing end of the recording material S has passed a flapper 61, the flapper 61 is flapped by an actuator (not illustrated), and the pair of discharge rollers 60 are rotated backward by a switching device (not illustrated). That is, as illustrated in FIG. 17B, the recording material S is switched back in such a manner as to be conveyed backward by the pair of discharge rollers 60 and is guided to a duplex conveying path 4 by the flapper 61. Subsequently, as illustrated in FIG. 18A, the recording material S is conveyed by first duplex conveying rollers 41 and second duplex conveying rollers 42 along a common conveying path 94 serving as a conveying path for both the recording material S and an original G, and is delivered to a U-turn portion 5. The recording material S that has passed through the U-turn portion 5 is conveyed by the pair of conveying rollers 33 to the transfer nip and to the fixing nip again as illustrated in FIG. 18B, whereby another toner image is transferred and fixed to a second side of the recording material S. Then, the recording material S is discharged by the pair of discharge rollers 60 and is stacked on the first discharge portion 40.

### Original Reading Process

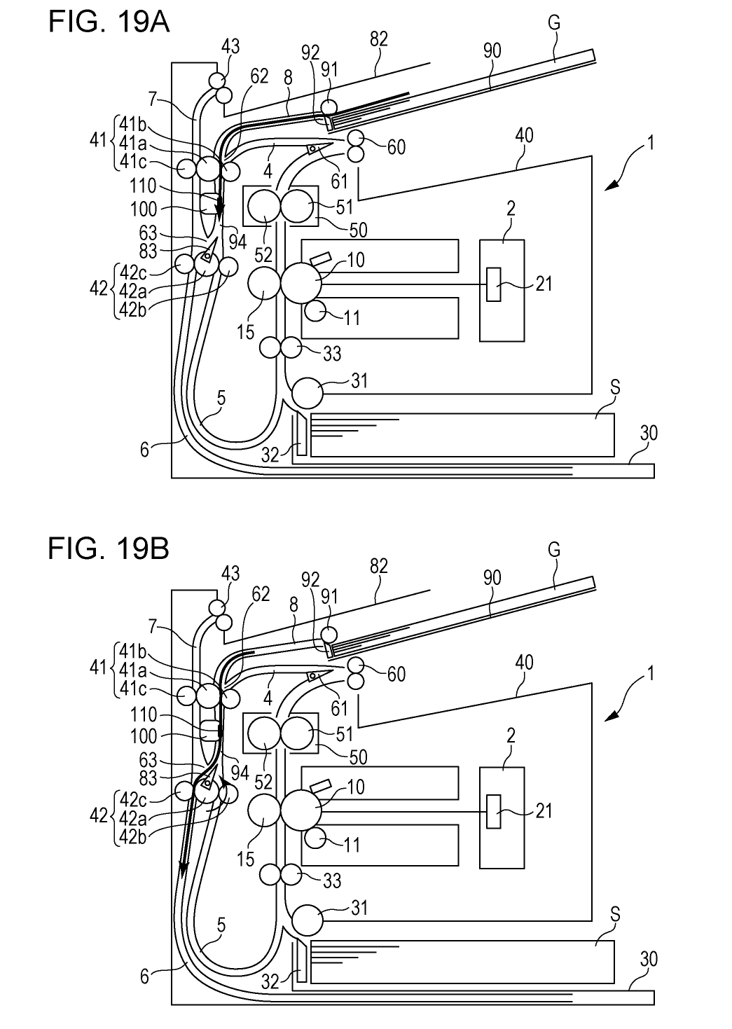

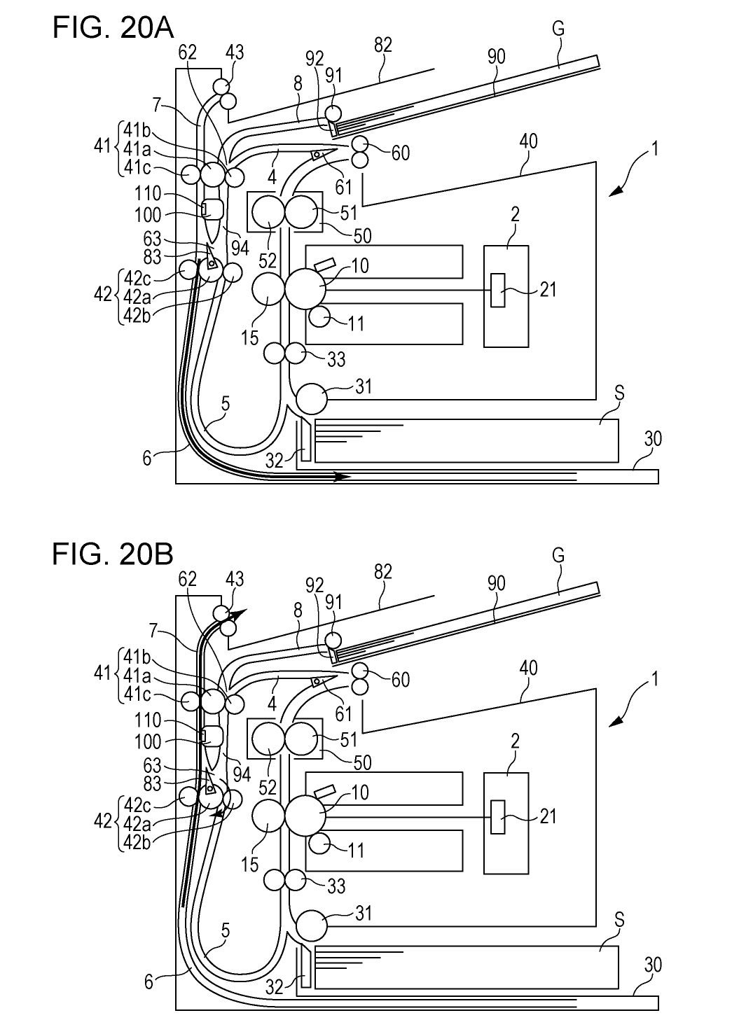

An original reading process will now be described with reference to FIGS. 19A to 20B. As illustrated in FIG. 19A, originals G placed on a second feed unit 90 are each fed by a pickup roller 91 and a separating member 92, and the thus fed original G is conveyed along an original-feeding path 8 into the common conveying path 94. Subsequently, the original G is conveyed by the first duplex conveying rollers 41 to a position facing the reading device 100 provided in the common conveying path 94. Then, the reading device 100 reads a first side of the original G while the original G is conveyed.

The reading device 100 is a so-called contact image sensor that includes a light source, a plurality of image pickup elements (forming a line sensor, not illustrated) aligned in a direction orthogonal to the direction of conveyance (in the direction of the axis of rotation of a driving roller 41a), and a plurality of imaging elements provided in correspondence with the image pickup elements. The reading device 100 reads an image on the original G as follows. The imaging elements receive the reflection from the surface of the original G and form the reflection into images on the respective image pickup elements, and the image pickup elements thus detect the images. The reading device 100 further includes a glass cover 110, which is a transmissive member. The cover 110 covers the light source, the plurality of imaging elements, and the plurality of image pickup elements provided in the reading device 100. In a state where the surface of the original G that is to be read is in contact with the surface of the cover 110, the surface of the original G that is to be read is positioned at an appropriate depth of focus. Hence, a surface of the reading device 100 that faces an object of reading (the original G in this case) and through which light reflected by the object of reading travels toward the plurality of image pickup elements is defined as the reading surface. In the fourth embodiment, the reading surface corresponds to the surface of the cover 110 that comes into contact with the original G.

Information thus read by the reading device 100 is stored as image information on the first side of the original G in a memory (not illustrated). The original G that has passed the reading device 100 passes a flapper 83 as illustrated in FIG. 19B and is conveyed to an original-reversing path 6. When the trailing end of the original G has passed the tip of the flapper 83, the flapper 83 is moved by an actuator (not illustrated) to a position (illustrated in FIG. 20A) where the flapper 83 closes the common conveying path 94 so as to prevent the original G from being conveyed to the common conveying path 94.

FIG. 20A illustrates a state after the completion of the reading of the first side of the original G and the switching of the direction of conveyance of the original G, and immediately before the start of a process of reading a second side of the original G. In this state, the second duplex conveying rollers 42 are rotated backward by a switching device (not illustrated), whereby the original G is switched back (conveyed in the reverse direction such that the trailing end of the original G now serves as the leading end). Thus, the original G is conveyed toward an original-discharging path 7.

FIG. 20B illustrates a state where the second side of the original G that has been switched back with the backward rotation of the second duplex conveying rollers 42 is being read. In the reading device 100, the positions of the image pickup elements and the cover 110 are changeable by rotating the reading device 100 about an axis of rotation (not illustrated). Specifically, the reading device 100 is rotatable and thus movable between a position (first position), illustrated in FIGS. 19A and 19B, for reading an original G that is in the common conveying path 94 and a position (second position), illustrated in FIGS. 20A and 20B, for reading an original G that is in the original-discharging path 7.

Focusing on the original reading process again, the reading device 100 that has acquired the image information on the first side of the original G while being at the first position rotates about the axis of rotation (not illustrated) by 180 degrees and thus moves to the second position. At the second position, the cover 110 faces the original G that is conveyed along the original-discharging path 7. The reading device 100 thus moved reads and acquires image information on the second side of the original G while the original G is conveyed along the original-discharging path 7. The image information thus acquired is stored in the memory (not illustrated).

The first duplex conveying rollers 41 are provided in the original-discharging path 7 on the downstream side of the reading device 100 in the direction of conveyance of the original G and in the common conveying path 94 on the upstream side of the reading device 100 in the direction of conveyance of the original G. The first duplex conveying rollers 41 include three rollers, specifically, the driving roller 41a and follower rollers 41b and 41c that nip the driving roller 41a from two respective sides with a predetermined pressure. The driving roller 41a is capable of conveying a recording material S or an original G that is in the common conveying path 94 in the downward direction in FIGS. 19A to 20B, and is capable of conveying an original G that is in the original-discharging path 7 in the upward direction in FIGS. 19A to 20B.

After the original G that is conveyed along the original-discharging path 7 is read by the reading device 100 that is at the second position, the original G is conveyed by the driving roller 41a and the follower roller 41c included in the first duplex conveying rollers 41 and is stacked onto the second discharge portion 82 by a pair of original-discharging rollers 43 provided on the downstream side of the first duplex conveying rollers 41.

After the completion of the reading of the second side of the original G, the reading device 100 is moved to such a position that a side thereof having the cover 110 faces the common conveying path 94 again so as to be prepared for the reading of a subsequent original G. If the user has selected simplex reading, it is possible to control the reading device 100 so as not to move.

After the image information on the first and second sides of the original G has been read, an image forming process in which the light-emitting portion 21 emits laser light to the photoconductor drum 10 on the basis of the image information on the first and second sides of the original G is ready to be performed on a recording material S. Alternatively, the image information on the first and second sides of the original G that has been read may be transmitted in the form of electronic data to a computer.

### Duplex Copying Operation

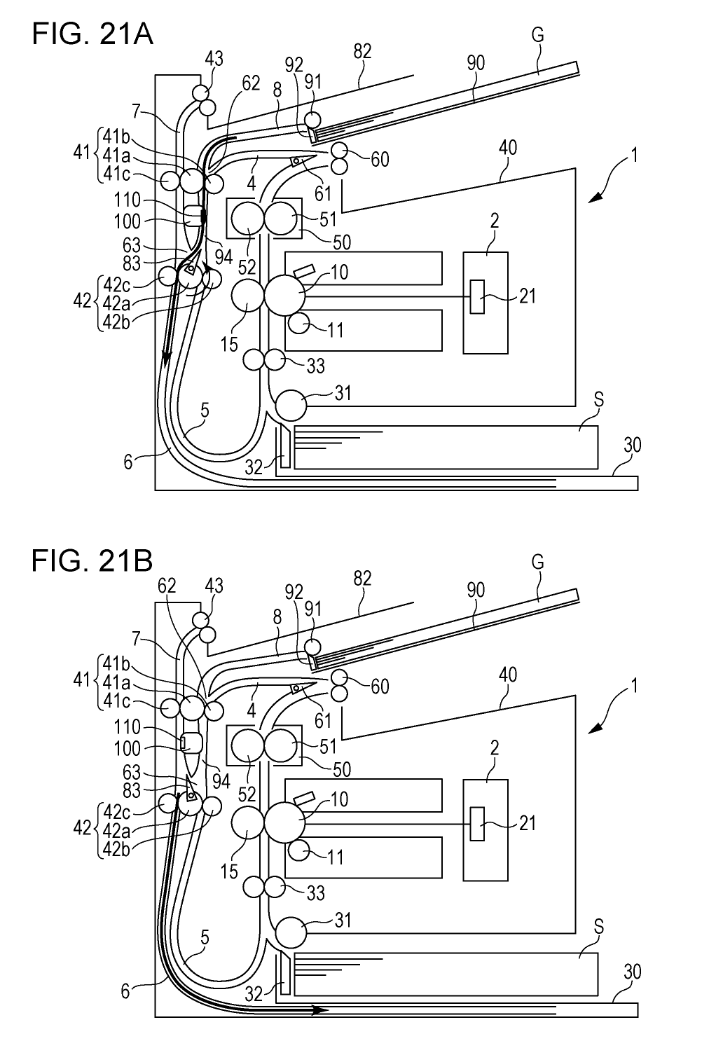

Referring to FIGS. 21A to 26, a duplex copying operation will now be described in which the original reading process and the image forming process are performed simultaneously. The duplex copying operation is an operation in which images based on respective pieces of image information on the first and second sides of the original G are copied on the first and second sides, respectively, of a recording material S.

The duplex copying operation starts with the reading of the original G by the reading device 100. As illustrated in FIG. 21A, originals G placed on the second feed unit 90 are each fed by the pickup roller 91 and the separating member 92. The original G thus fed passes through a merging point 62 into the common conveying path 94 and is further conveyed by the first duplex conveying rollers 41 to a position facing the reading device 100 that is at the first position. The reading device 100 reads the first side of the original G that is being conveyed. The flapper 83 allows the original G in the common conveying path 94 to pass through a merging point 63 and to proceed to the original-reversing path 6. Thus, the reading of the first side of the original G is complete. The image information on the first side of the original G thus read by the reading device 100 is stored in the memory (not illustrated).

Referring now to FIG. 21B, when the trailing end of the original G that is being conveyed along the original-reversing path 6 has passed the merging point 63, the flapper 83 is moved by the actuator (not illustrated) to the position where the flapper 83 closes the common conveying path 94 so as not to allow the original G to be conveyed to the common conveying path 94. In this step, the reading device 100 rotates by 180 degrees and take the position for reading the second side of the original G.

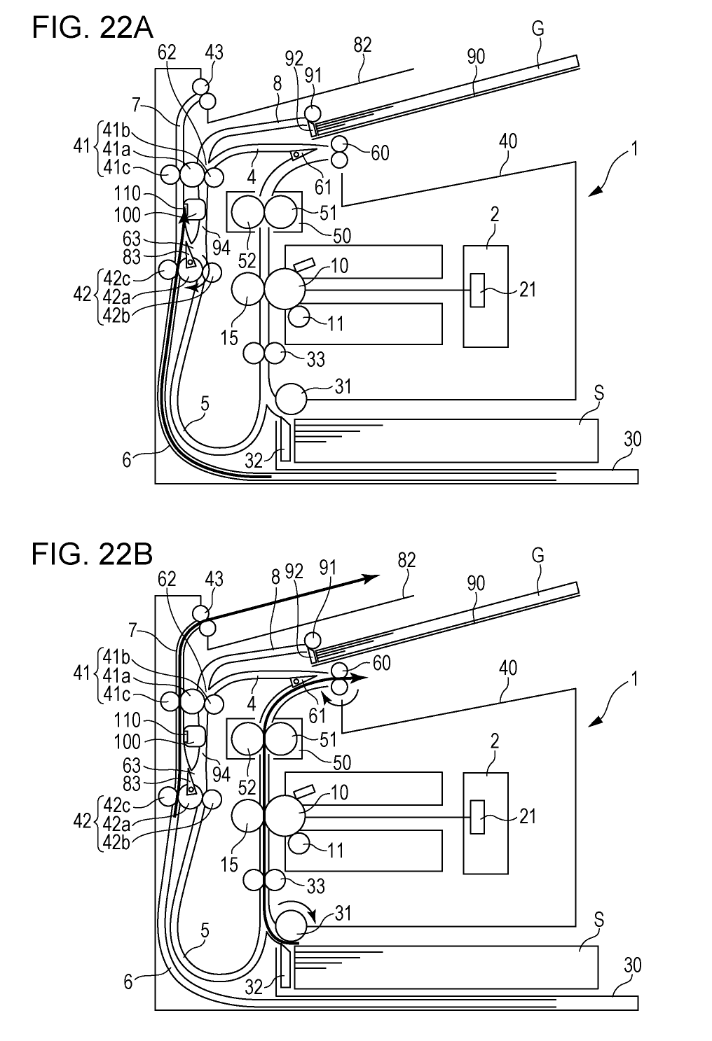

Subsequently, as illustrated in FIG. 22A, the second duplex conveying rollers 42 are rotated backward, whereby the original G is switched back and is conveyed to the original-discharging path 7, where the second side of the original G starts to be read by the reading device 100 that is at the second position. While the original G is conveyed, the image information on the second side of the original G that has been read by the reading device 100 is stored in the memory (not illustrated).

Subsequently, as illustrated in FIG. 22B, an image forming process is performed in which a toner image based on the image information on the first side of the original G stored in the memory (not illustrated) is formed on the first side of a recording material S. In FIG. 22B, the operation of reading the second side of the original G and the image forming process of forming an image on the recording material S are performed simultaneously. In the operation of reading the second side of the original G, the original G is conveyed by the first duplex conveying rollers 41 and the pair of original-discharging rollers 43 provided at respective positions of the second original-conveying path 7 that are on the downstream side of the reading device 100 in the direction of conveyance of the original G. Meanwhile, in the image forming process, recording materials S stored in the first feed unit 30 are each picked up by the pickup roller 31 and the separating member 32, and the recording material S thus picked up is conveyed by the pair of conveying rollers 33. Then, a toner image formed on the photoconductor drum 10 is transferred to the recording material S at the transfer portion and is fixed to the recording material S by the fixing portion 50.

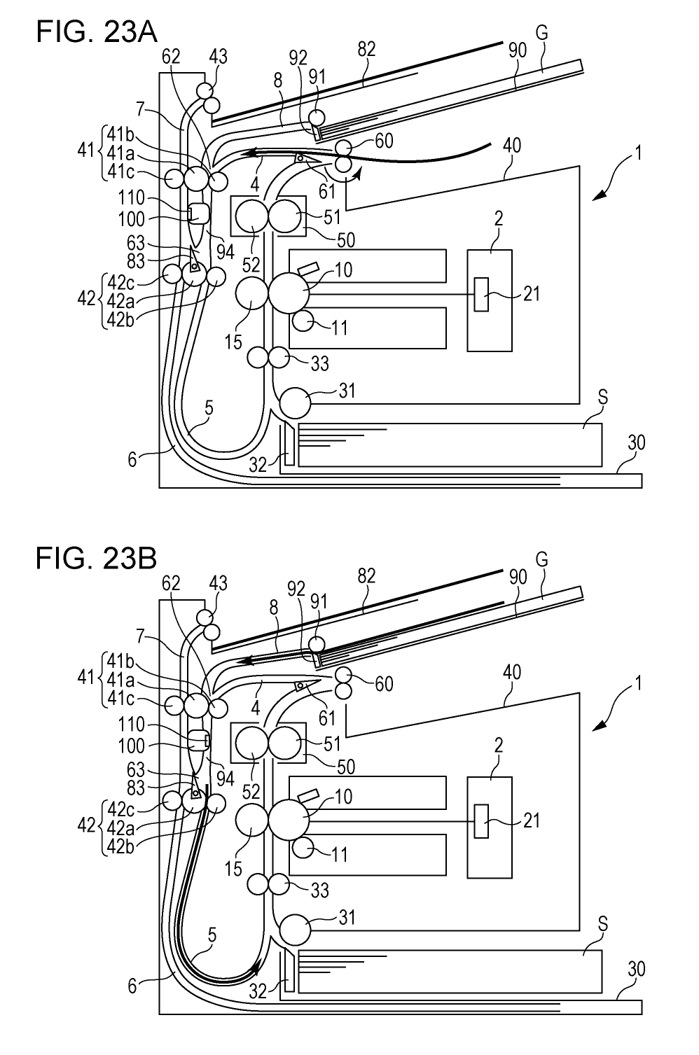

Referring now to FIG. 23A, the original G that has undergone the reading of the second side thereof is discharged to the second discharge portion 82. Meanwhile, the recording material S is conveyed to the duplex conveying path 4 by the pair of discharge rollers 60 rotating backward, passes through the merging point 62, and is further conveyed through the common conveying path 94 to the U-turn portion 5 by the first duplex conveying rollers 41 and the second duplex conveying rollers 42. The flapper 83 provided at the merging point 63 is at the position where the flapper 83 closes the original-reversing path 6 so as to convey the recording material S to the U-turn portion 5. In this step, the reading device 100 is retained at the second position where the reading device 100 is ready for reading the second side of the original G.

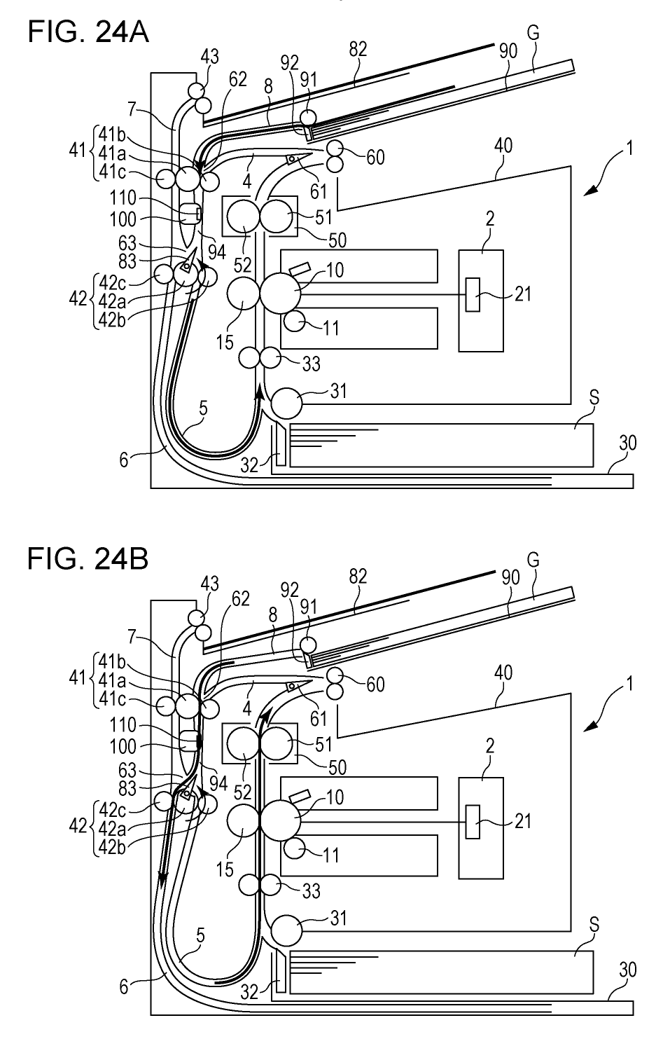

Referring now to FIG. 23B, after the recording material S has reached the U-turn portion 5 and the trailing end of the recording material S has passed the merging point 63 in the common conveying path 94, the reading device 100 is rotated and comes to face the common conveying path 94 so as to be prepared for the reading of the first side of a second original G that is to be fed from the second feed unit 90 following the conveyance of the recording material S. Then, the second original G is picked up and fed from the second feed unit 90. After the trailing end of the preceding recording material S has passed the merging point 63 in the common conveying path 94 and the nip between the second duplex conveying rollers 42, the flapper 83 is flapped to a position illustrated in FIG. 24A and the second duplex conveying rollers 42 are rotated backward.

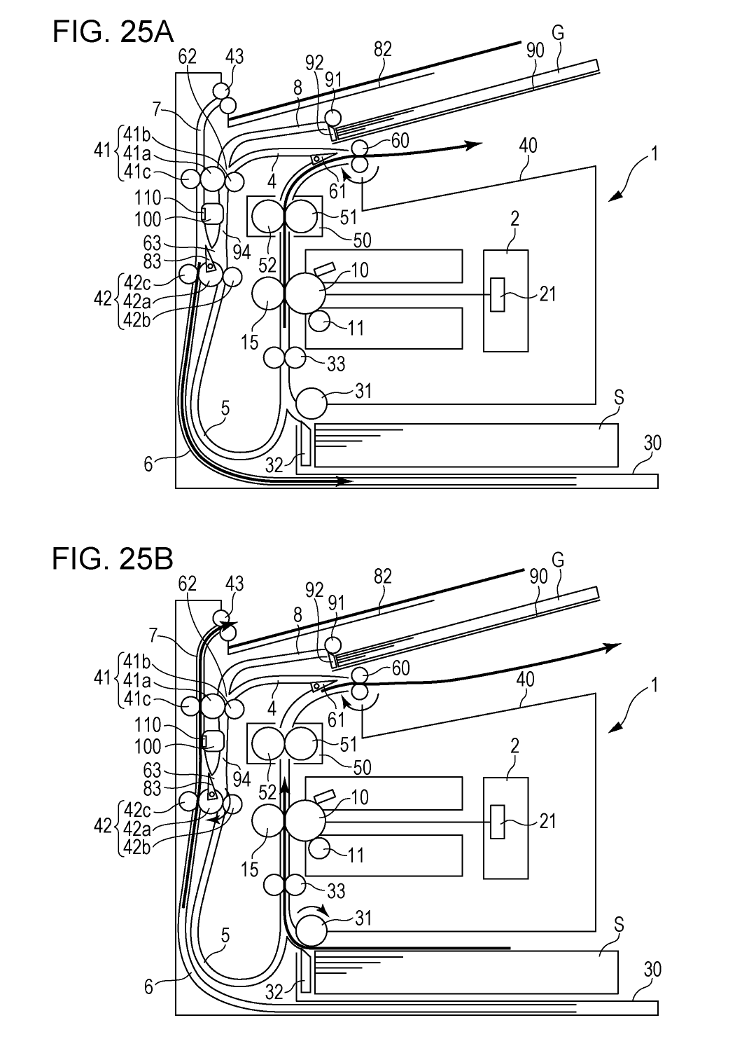

Subsequently, as illustrated in FIG. 24B, the second original G that has been fed from the second feed unit 90 passes the merging point 62, is conveyed along the common conveying path 94, where the first side of the second original G is read by the reading device 100. Then, the second original G passes the merging point 63 where the flapper 83 is provided, and is conveyed to the original-reversing path 6. Thus, the reading of the first side of the second original G is complete. In this step, the second original G is in the same state as the first original G illustrated in FIG. 21A. Meanwhile, the recording material S is conveyed along the U-turn portion 5 through the transfer nip to the fixing nip by the pair of conveying rollers 33 again, whereby a toner image based on the image information on the second side of the first original G is transferred and fixed to the second side of the recording material S. Then, as illustrated in FIG. 25A, the recording material S is conveyed toward the first discharge portion 40 by the pair of discharge rollers 60.

Subsequently, as illustrated in FIG. 25B, a second recording material S corresponding to the second original G is fed, and an image forming process for the second recording material S is started. Simultaneously, the flapper 83 is flapped, and the second duplex conveying rollers 42 are rotated backward, whereby the second original G is conveyed from the original-reversing path 6 to the original-discharging path 7. Then, the second side of the second original G starts to be read (as in the case of the first original G illustrated in FIG. 22A).

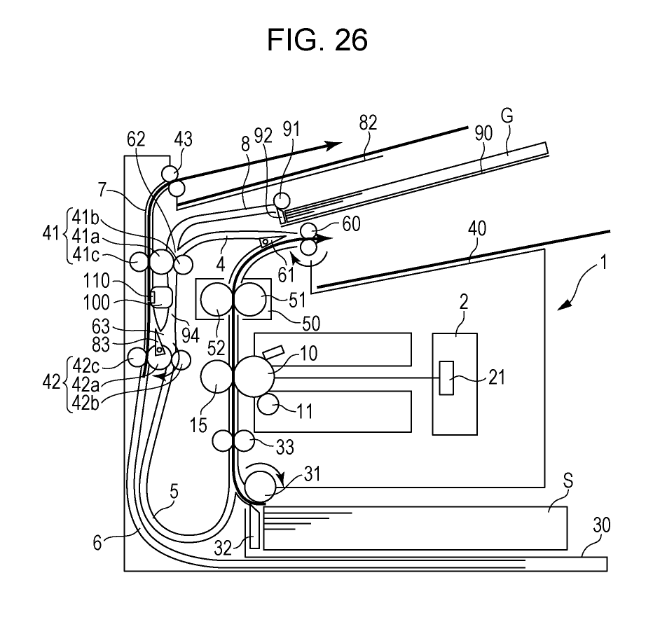

Subsequently, as illustrated in FIG. 26, the first recording material S having the images corresponding to the first and second sides of the first original G on the first and second sides thereof, respectively, is discharged to the first discharge portion 40 by the pair of discharge rollers 60. The toner image based on the image information on the first side of the second original G and having been formed on the photoconductor drum 10 at the transfer nip is transferred to the second recording material S, and the second recording material S is conveyed to the fixing nip. This step is performed simultaneously with the reading of the second side of the second original G. In this step, the states of the second original G and the second recording material S are the same as those illustrated in FIG. 22B.

Subsequently, if the copying operation is continued successively, the process illustrated in FIGS. 23A to 26 is repeated a desired number of times. Thus, the duplex copying operation is complete.

In the above duplex copying operation, pieces of image information on the first and second sides of the original G are copied on the first and second sides, respectively, of the recording material S. Alternatively, while the original reading process and the image forming process are performed simultaneously in the above-described manner, an image that does not correspond to either of the images read from the original G may be formed on the recording material S.

### Retraction of Reading Device 100

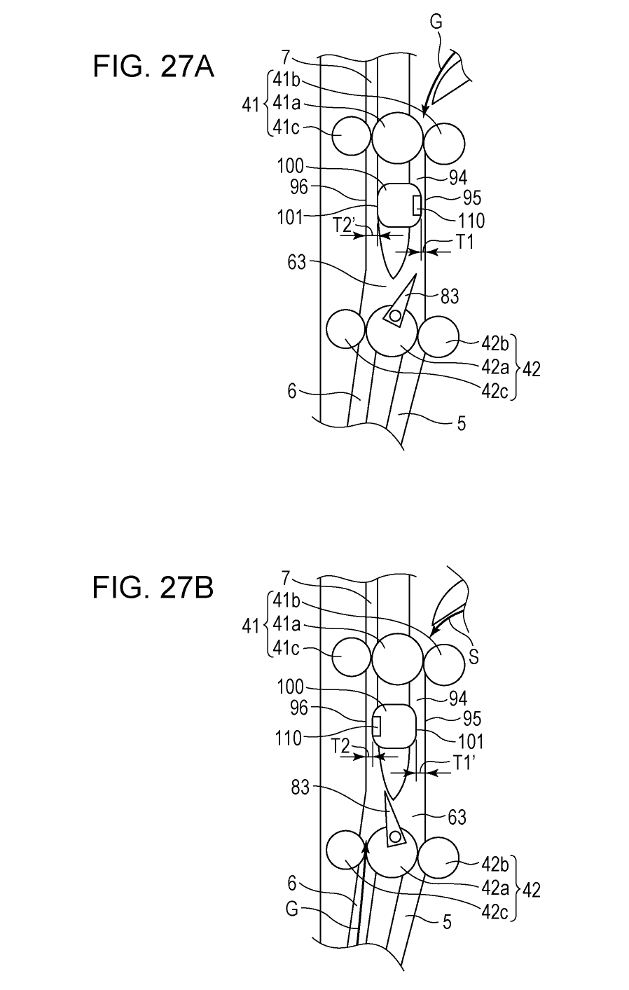

The retraction of the reading device 100 from the common conveying path 94 will now be described in detail. FIGS. 27A and 27B are enlarged views of part of the image forming apparatus 1 illustrating the reading device 100 and peripheral elements. FIG. 27A illustrates a state where the reading device 100 is at the first position for reading an original G that is in the common conveying path 94. FIG. 27B illustrates a state where the reading device 100 is at the second position for reading an original G that is in the original-discharging path 7 (a position where the reading device 100 does not read the original G that is in the common conveying path 94).

When the reading device 100 is at the first position as illustrated in FIG. 27A, a sheet (the recording material S or the original G) that is conveyed along the common conveying path 94 passes through a space between the cover 110 of the reading device 100 and a counter guide 95 that defines a portion of the common conveying path 94. A sheet (the original G) that is conveyed along the original-discharging path 7 passes through a space between a back face 101 of the reading device 100 (a side of the reading device 100 that is across the axis of rotation thereof from the cover 110) and a counter guide 96 that defines a portion of the original-discharging path 7. Here, the distance between the surface of the cover 110 of the reading device 100 and the surface of the counter guide 95 (one of facing surfaces) is denoted as distance T1, and the distance between the back face 101 of the reading device 100 and the surface of the counter guide 96 (the other facing surface) is denoted as distance T2′.

The counter guide 95 defines at least a portion of the common conveying path 94 and is a member provided at a position facing the reading device 100. The counter guide 96 defines at least a portion of the original-discharging path 7 and is a member provided at a position facing the reading device 100. The back face 101 serves as a guide surface that guides the sheet that is conveyed along the original-discharging path 7.

When the reading device 100 is at the second position as illustrated in FIG. 27B, a sheet (the recording material S or the original G) that is conveyed along the common conveying path 94 passes through a space between the back face 101 of the reading device 100 and the counter guide 95 that defines a portion of the common conveying path 94. A sheet (the original G) that is conveyed along the original-discharging path 7 passes through a space between the cover 110 of the reading device 100 and the counter guide 96 that defines a portion of the original-discharging path 7. Here, the distance between the surface of the cover 110 of the reading device 100 and the surface of the counter guide 96 (the other facing surface) is denoted as distance T2, and the distance between the back face 101 of the reading device 100 and the surface of the counter guide 95 (the one facing surface) is denoted as distance T1′.

The back face 101 serves as a guide surface that guides the sheet that is conveyed along the common conveying path 94.

As described above, the surface of the original G that is to be read is set so as to be at an appropriate depth of focus by coming into contact with the surface of the cover 110 of the reading device 100. Hence, the distances T1 and T2 are set to relatively small values that are roughly equivalent to the thickness of the original G so that the original G comes into contact with the surface of the cover 110 when the original G is read.

Meanwhile, when the image forming process of forming images on both sides of the recording material S or the duplex copying operation described above or any other similar operation is performed, the recording material S that has been heated by passing through the fixing portion 50 passes through the common conveying path 94. The imaging elements and the image pickup elements provided in the reading device 100 reside near the cover 110. When the reading device 100 is at the first position (a reading position where the reading device 100 is ready for reading the sheet that is in the common conveying path 94), the recording material S that has been heated comes into contact with the cover 110. Consequently, the temperature of the elements such as the image pickup elements and the imaging elements may be raised by the heat transmitted thereto via the cover 110, leading to reading failure or damage depending on the situation.

Hence, when the recording material S that has passed through the fixing portion 50 passes through the common conveying path 94, the reading device 100 is moved from the first position as the reading position where the reading device 100 is ready for reading the sheet that is in the common conveying path 94 to the second position that is at 180 degrees with respect to the first position. Thus, the reading device 100 is controlled so as to be retracted from the common conveying path 94. Since the cover 110 is retracted to the second position as the retracted position, the occurrence of failure due to the rise of the temperatures of the light source, the imaging elements, and the image pickup elements provided in the reading device 100 with the heat transmitted thereto via the cover 110 is suppressed.

The back face 101 of the reading device 100 is made of a material having a lower thermal conductivity than the cover 110, which is made of glass. Furthermore, a space (an air layer, not illustrated) is provided between the back face 101 and the image pickup elements (not illustrated) provided in the reading device 100 and serves as a heat insulating layer that suppresses the transmission of heat from the back face 101 to the image pickup elements. Alternatively, any other heat insulating member may be provided between the back face 101 and the image pickup elements (not illustrated) provided in the reading device 100.

The distance T1′ between the counter guide 95 defining the common conveying path 94 and the back face 101 when the reading device 100 is at the second position is larger than the distance T1 between the counter guide 95 defining the common conveying path 94 and the surface of the cover 110 when the reading device 100 is at the first position.

That is, the following relationship holds:

T1<T1′

Setting the distance between the reading device 100 and the counter guide 95 as described above lowers the probability that heat may be transmitted to the light source, the image pickup elements, the imaging elements, and other elements provided in the reading device 100 via the back face 101 of the reading device 100 when the recording material S that has passed through the fixing portion 50 passes through the common conveying path 94 with the reading device 100 being at the second position. Consequently, the heating of the reading device 100 is more suppressed.

Setting the distance between the reading device 100 and the counter guide 95 as described above provides another advantage. In the fourth embodiment, the reading device 100 is controlled so as to be at the second position when the reading device 100 at the first position does not perform reading in a case where the recording material S passes through the common conveying path 94 or the original G whose second side is only subject to reading passes through the common conveying path 94. Such a configuration lowers the probability of a jam that may occur because the recording material S or the original G passing through the common conveying path 94 when the reading device 100 at the first position does not perform reading comes into contact with and is thus caught by the reading device 100. Particularly, since the recording material S that has passed through the fixing portion 50 is soft (flexible) and is easy to buckle, such a recording material S tends to cause a jam by coming into contact with the reading device 100. Hence, it is effective to set the distance between the reading device 100 and the counter guide 95 as described above.

In the above case, the reading device 100 is rotated by 180 degrees from the first position, thereby being moved to the second position retracted from the common conveying path 94. The angle of rotation is not necessarily 180 degrees, as long as the cover 110 is moved to a position that is retracted from the common conveying path 94. In the fourth embodiment, if the reading device 100 is rotated from the first position by about 90 degrees or more, the cover 110 moves to a position that is not exposed to the common conveying path 94. Hence, the reading device 100 only needs to be movable to a retracted position that is at about 90 degrees or more with respect to the first position.

If the reading device 100 is at such a retracted position, the surface of the reading device 100 that faces the counter guide 95 defining the common conveying path 94 may correspond to a side face of the reading device 100. In such a case, letting the distance between the counter guide 95 and the side face of the reading device 100 be T1′, if the distance T1′ is larger than the distance T1 described above, the problem due to the rise of the temperature and the problem of the occurrence of a jam are solved.

In the fourth embodiment, the distance between the reading device 100 and the counter guide 96 is set likewise. That is, the distance T2′ between the counter guide 96 defining the original-discharging path 7 and the back face 101 of the reading device 100 that is at the first position is larger than the distance T2 between the counter guide 96 defining the original-discharging path 7 and the surface of the cover 110 of the reading device 100 that is at the second position.

That is, the following relationship holds:

T2<T2′

where the distance T2 is equal to the distance T1, and the distance T2′ is equal to the distance T1′.

While the distance between the reading device 100 and the counter guide 96 is set as described above, the reading device 100 is controlled so as to be at the first position when the reading device 100 at the second position does not perform reading. Such a configuration lowers the probability of a jam that may occur because, when the original G whose second side is only subject to reading passes through the original-discharging path 7, the original G comes into contact with and is thus caught by the reading device 100.

To summarize, according to the fourth embodiment, the deterioration in the reading accuracy of the reading device 100 and the occurrence of damage to the reading device 100 due to the rise of the temperature of the reading device 100 with the heat of the recording material S are suppressed.

According to each of the first to fourth embodiments, the object to be read by the reading device 100 or 200 is an image on the original G. However, the object to be read by the reading device 100 is not limited to an image on a sheet such as the original G. For example, to identify the type of a sheet, the contrast or the like on the surface of the sheet may be read.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-096024, filed Apr. 30, 2013, Japanese Patent Application No. 2013-096025, filed Apr. 30, 2013, and Japanese Patent Application No. 2014-088606, filed Apr. 22, 2014, which are hereby incorporated by reference herein in their entirety.

What is claimed is:

1. An image reading apparatus comprising:
a reading unit having a reading surface and being rotatable about an axis of rotation, the reading unit being capable of reading a portion of an object that faces the reading surface when the reading unit is at a reading position; and
a facing member that comes into contact with the reading unit and faces the reading surface when the reading unit is at the reading position,
wherein, when the reading unit is at a position other than the reading position, the reading surface is positioned nearer to the axis of rotation than when the reading unit is at the reading position and the reading unit is spaced apart from the facing member.

2. The image reading apparatus according to claim 1,
wherein, when the reading unit rotates from the reading position, the reading surface moves toward the axis of rotation in conjunction with the rotation of the reading unit about the axis of rotation.

3. The image reading apparatus according to claim 1, further comprising:
a regulating member that regulates a position of the reading unit in a radial direction with respect to the axis of rotation; and
a pressing member that presses the reading unit toward the regulating member.

4. The image reading apparatus according to claim 3,
wherein, when the reading unit is at the reading position, the regulating member is capable of regulating the rotation of the reading unit.

5. The image reading apparatus according to claim 3, further comprising:
a holding member that holds the reading unit,
wherein the reading unit rotates about the axis of rotation when the holding member rotates.

6. The image reading apparatus according to claim 5,
wherein the pressing member is an elastic member provided between the holding member and the reading unit.

7. The image reading apparatus according to claim 1,
wherein, when the reading unit rotates from the reading position, the reading surface of the reading unit moves toward the axis of rotation before the reading unit rotates about the axis of rotation.

8. The image reading apparatus according to claim 1, further comprising:
a first conveying path along which a sheet is conveyed,
wherein the reading unit is movable to a first position as the reading position where an image on the sheet that is in the first conveying path is read with the sheet being held between the reading surface and the facing member.

9. The image reading apparatus according to claim 8, further comprising:
a second conveying path along which the sheet is conveyed,
wherein, after the sheet passes through the first conveying path and is switched back, the sheet is conveyed to the second conveying path and the reading unit is allowed to move to a second position as the reading position where another image on the sheet that is in the second conveying path is read with the sheet being held between the reading surface and the facing member.

10. The image reading apparatus according to claim 9, further comprising:
a reference portion that is to be read by the reading unit when reference information is acquired,
wherein the reading unit is movable to a third position as the reading position where the reading unit reads the reference portion.

11. The image reading apparatus according to claim 1,
wherein the axis of rotation is parallel to a surface of the sheet that is to be read through the reading surface.

12. The image reading apparatus according to claim 8, further comprising:
an image forming unit that is capable of forming an image on a sheet.

13. The image reading apparatus according to claim 12,
wherein the image forming unit includes a conveying path along which the sheet on a first side of which an image has been formed is conveyed to the image forming unit again for formation of another image on a second side of the sheet, a portion of the conveying path serving as the first conveying path.

14. An image reading apparatus comprising:
a reading unit having a reading surface and being rotatable about an axis of rotation, the reading unit being capable of reading a portion of an object that faces the reading surface when the reading unit is at a reading position; and
a facing member that comes into contact with the reading unit and faces the reading surface when the reading unit is at the reading position,
wherein, when the reading unit is at a position other than the reading position, the facing member is positioned farther from the axis of rotation than when the reading unit is at the reading position and the facing member is spaced apart from the reading unit.

15. The image reading apparatus according to claim 14,
wherein, when the reading unit rotates from the reading position, the facing member moves away from the axis of rotation in conjunction with the rotation of the reading unit about the axis of rotation.

16. The image reading apparatus according to claim 14, further comprising:
a pressing member that presses the facing member toward the axis of rotation; and
a regulating member that regulates a position of the facing member in a direction toward the axis of rotation.

17. The image reading apparatus according to claim 16,
wherein the regulating member moves synchronously with the rotation of the reading unit.

18. The image reading apparatus according to claim 16,
wherein, when the reading unit is at the reading position, the facing member is capable of regulating the rotation of the reading unit via the regulating member.

19. The image reading apparatus according to claim 14,
wherein, when the reading unit rotates from the reading position, the facing member moves away from the axis of rotation before the reading unit rotates about the axis of rotation.

20. The image reading apparatus according to claim 14, further comprising:
a first conveying path along which a sheet is conveyed,
wherein the reading unit is movable to a first position as the reading position where an image on the sheet that is in the first conveying path is read with the sheet being held between the reading surface and the facing member.

21. The image reading apparatus according to claim 20, further comprising:
a second conveying path along which the sheet is conveyed,
wherein, after the sheet passes through the first conveying path and is switched back, the sheet is conveyed to the second conveying path and the reading unit is allowed to move to a second position as the reading position where another image on the sheet that is in the second conveying path is read with the sheet being held between the reading surface and the facing member.

22. The image reading apparatus according to claim 21, further comprising:
a reference portion that is to be read by the reading unit when reference information is acquired,
wherein the reading unit is movable to a third position as the reading position where the reading unit reads the reference portion.

23. The image reading apparatus according to claim 14,
wherein the axis of rotation is parallel to a surface of the sheet that is to be read through the reading surface.

24. The image reading apparatus according to claim 20, further comprising:
an image forming unit that is capable of forming an image on a sheet.

25. The image reading apparatus according to claim 24,
wherein the image forming unit includes a conveying path along which the sheet on a first side of which an image has been formed is conveyed to the image forming unit again for formation of another image on a second side of the sheet, a portion of the conveying path serving as the first conveying path.

26. An image reading apparatus comprising:
a reading unit having a reading surface and being rotatable about an axis of rotation, the reading unit being capable of reading a portion of an object that faces the reading surface when the reading unit is at a reading position;
a pressing member that presses the reading unit in a radial direction with respect to the axis of rotation; and
a regulating member that regulates a position of the reading unit in the radial direction,
wherein the regulating member regulates the position of the reading unit such that the reading surface is nearer to the axis of rotation in the radial direction when the reading unit is at a position other than the reading position than when the reading unit is at the reading position.

27. The image reading apparatus according to claim 26, further comprising:
a facing member that faces the reading surface when the reading unit is at the reading position,
wherein, when the reading unit is at the reading position, the position of the reading unit in the radial direction is determined with the reading unit coming into contact with the facing member.

28. The image reading apparatus according to claim 27, further comprising:
a first conveying path along which a sheet is conveyed,
wherein the reading unit is movable to a first position as the reading position where an image on the sheet that is in the first conveying path is read with the sheet being held between the reading surface and the facing member.

29. The image reading apparatus according to claim 28, further comprising:
a second conveying path along which the sheet is conveyed,
wherein, after the sheet passes through the first conveying path and is switched back, the sheet is conveyed to the second conveying path and the reading unit is allowed to move to a second position as the reading position where another image on the sheet that is in the second conveying path is read with the sheet being held between the reading surface and the facing member.

30. The image reading apparatus according to claim 28,
wherein the axis of rotation is parallel to a surface of the sheet that is to be read through the reading surface.

31. An image forming apparatus comprising:
a reading unit that reads an image on a sheet that is to face a reading surface thereof;
a facing surface that forms at least a portion of a conveying path along which the sheet is conveyed, the facing surface facing the reading unit;
a transfer portion where a toner image is transferred to a recording material; and
a fixing portion that fixes the toner image to the recording material by heating the recording material to which the toner image has been transferred,
wherein the recording material that has passed through the fixing portion is conveyed along the conveying path,
wherein the reading unit is movable between a reading position where the reading unit reads the sheet positioned between the reading surface and the facing surface and a retracted position where the reading surface is farther from the facing surface than when the reading unit is at the reading position, and
wherein the reading unit is at the retracted position when the recording material that has passed through the fixing portion is conveyed along the conveying path.

32. The image forming apparatus according to claim 31,
wherein the reading unit includes a guide surface that guides the sheet, the guide surface facing the facing surface when the reading unit is at the retracted position, and
wherein a distance between the guide surface and the facing surface when the reading unit is at the retracted position is longer than a distance between the reading surface and the facing surface when the reading unit is at the reading position.

33. The image forming apparatus according to claim 31,
wherein the reading unit reads the sheet that is in contact with the reading surface when the reading unit is at the reading position.

34. The image forming apparatus according to claim 31,
wherein the reading unit moves from the reading position to the retracted position by undergoing rotation.

35. The image forming apparatus according to claim 34,
wherein the reading unit takes the retracted position by rotating by at least 90 degrees from the reading position.

36. The image forming apparatus according to claim 31, further comprising:
another facing surface that forms at least a portion of another conveying path along which the sheet is conveyed,
wherein the reading unit reads the sheet residing between the reading surface and the other facing surface when the reading unit is at the retracted position.

37. The image forming apparatus according to claim 36,
wherein, when the reading unit is at the reading position, the reading unit reads a first side of the sheet that is conveyed along the conveying path, and
wherein, when the reading unit is at the retracted position, the reading unit reads a second side of the sheet that is conveyed along the another conveying path after being conveyed along the conveying path.
